(19) United States
(12) Patent Application Publication
(10) Pub. No.: US 2025/0187468 A1
(43) Pub. Date: Jun. 12, 2025

(54) VEHICLE POWER CONVERTER

(71) Applicant: KABUSHIKI KAISHA TOYOTA JIDOSHOKKI, Aichi (JP)

(72) Inventors: Takahiro SUZUKI, Aichi (JP); Atsushi YAMAGUCHI, Aichi (JP); Yusuke YAMAMOTO, Aichi (JP)

(73) Assignee: KABUSHIKI KAISHA TOYOTA JIDOSHOKKI, Aichi (JP)

(21) Appl. No.: 18/965,199

(22) Filed: Dec. 2, 2024

(30) Foreign Application Priority Data
Dec. 6, 2023 (JP) 2023-206064

(51) Int. Cl. B60L 53/22; H02J 7/02; H02M 1/14; H02M 3/335; H02M 7/219

(52) U.S. Cl. CPC B60L 53/22; H02J 7/02; H02M 1/14; H02M 3/33584; H02M 7/219; B60L 2210/10; B60L 2210/30; B60L 2270/20; H02J 2207/20

(57) ABSTRACT

A vehicle power converter mounted on a vehicle includes connectors, an AC-DC power conversion circuit, a smoothing capacitor, a bidirectional DC-DC power conversion circuit, a switch that is provided between the smoothing capacitor and at least one of the connectors, and a controller. The controller executes battery charging preparation operation when the controller determines that the vehicle power converter is connected to the external power supply as follows: after the controller controls operation of the bidirectional DC-DC power conversion circuit while keeping a connection state between the smoothing capacitor and the connectors in a disconnected state by the switch such that a power output from the battery is supplied to the smoothing capacitor, the controller causes a connection state of the switch to transition from a disconnected state to a connected state.

### CROSS-REFERENCE OF THE RELATED APPLICATION

This application claims priority to Japanese Patent Application No. 2023-206064 filed on Dec. 6, 2024, the entire disclosure of which is incorporated herein by reference.

### BACKGROUND ART

The present disclosure relates to a vehicle power converter.

There is known a vehicle power converter that operates as follows: converting an alternating current power (AC power) output from an external power supply device such as a charge station to a direct current power (DC power) by rectifying the AC power using an AC-DC power conversion circuit and by smoothing the rectified AC power using a smoothing capacitor; converting the DC power to a DC power corresponding to a target DC power by a bidirectional DC-DC power conversion circuit; and supplying the DC power to a battery mounted on a vehicle. Furthermore, in this vehicle power converter, before the power is output from the external power supply device to the vehicle power converter, the smoothing capacitor is charged using a power output from the battery. This prevents a relatively large inrush current from flowing into the smoothing capacitor when the power is output from the external power supply to the vehicle power converter. Japanese Patent Application Publication No. 2022-054686 is known as a prior art related to this vehicle power converter.

When the external power supply device does not have a function for controlling a power output timing, the power may be output from the external power supply device to the vehicle power converter at a time when the external power supply device and the vehicle power converter are connected to each other, that is, when a connector of the charge station is inserted into the vehicle. This may cause the smoothing capacitor not to be pre-charged.

Here, there is known another vehicle power converter including a circuit in which a resistor and a switch that are connected in parallel with each other is provided on an input side of a smoothing capacitor, the vehicle power converter limiting an inrush current flowing into the smoothing capacitor by the resistor and turning the switch from off to on after the smoothing capacitor is charged.

However, in such a vehicle power converter, the resistor and the switch are required in order to limit the inrush current flowing into the smoothing capacitor, which leads to a concern about an increase of manufacturing costs of the vehicle power converter.

The present disclosure is partially directed to suppressing an increase of manufacturing costs of a vehicle power converter while it is suppressed that a relatively large inrush current flows into a smoothing capacitor in the vehicle power converter when a power is supplied from an external power supply to the vehicle power converter.

### SUMMARY

In accordance with an aspect of the present disclosure, there is provided a vehicle power converter mounted on a vehicle, the vehicle power converter that includes connectors to which a power output from an external power supply is input, an AC-DC power conversion circuit that converts, when the power input to the connectors is an AC power, the AC power to a DC power by rectifying the AC power, a smoothing capacitor that smooths the DC power rectified by the AC-DC power conversion circuit, a bidirectional DC-DC power conversion circuit that converts the DC power smoothed by the smoothing capacitor to a DC power corresponding to a target DC power and supplies the DC power to a battery mounted on the vehicle, a switch that is provided between the smoothing capacitor and at least one of the connectors, and a controller that controls operation of each of the AC-DC power conversion circuit, the bidirectional DC-DC power conversion circuit, and the switch. The controller executes battery charging preparation operation when the controller determines that the vehicle power converter is connected to the external power supply. In the battery charging preparation operation, after the controller controls the operation of the bidirectional DC-DC power conversion circuit while keeping a connection state between the smoothing capacitor and the connectors in a disconnected state by the switch such that a power output from the battery is supplied to the smoothing capacitor, the controller causes a connection state of the switch to transition from a disconnected state to a connected state.

Other aspects and advantages of the disclosure will become apparent from the following description, taken in conjunction with the accompanying drawings, illustrating by way of example the principles of the disclosure.

### BRIEF DESCRIPTION OF THE DRAWINGS

The disclosure, together with objects and advantages thereof, may best be understood by reference to the following description of the embodiments together with the accompanying drawings in which:

FIG. 1 is a diagram illustrating an example of a vehicle power converter according to a present embodiment;

FIG. 2A is a diagram illustrating an example of an AC-DC power conversion circuit and FIG. 2B is an example of a bidirectional DC-DC power conversion circuit;

FIG. 3 is a diagram illustrating a modified example 1 of the vehicle power converter according to the present embodiment;

FIG. 4 is a diagram illustrating a modified example 2-1 of the vehicle power converter according to the present embodiment;

FIG. 5 is a diagram illustrating an example of a switching circuit illustrated in FIG. 4;

FIG. 6 is a diagram illustrating a modified example 2-2 of the vehicle power converter according to the present embodiment;

FIG. 7 is a diagram illustrating an example of a switching circuit illustrated in FIG. 6;

FIG. 8 is a diagram illustrating a modified example 2-3 of the vehicle power converter according to the present embodiment;

FIG. 9 is a diagram illustrating a modified example 2-4 of the vehicle power converter according to the present embodiment;

FIG. 10 is a diagram illustrating a modified example 3 of the vehicle power converter according to the present embodiment;

FIG. 11 is a diagram illustrating a modified example 4 of the vehicle power converter according to the present embodiment; and

FIG. 12 is a diagram illustrating a modified example 5 of the vehicle power converter according to the present embodiment.

### DETAILED DESCRIPTION OF THE EMBODIMENTS

The following will describe an embodiment of the present disclosure with reference to the drawings in detail.

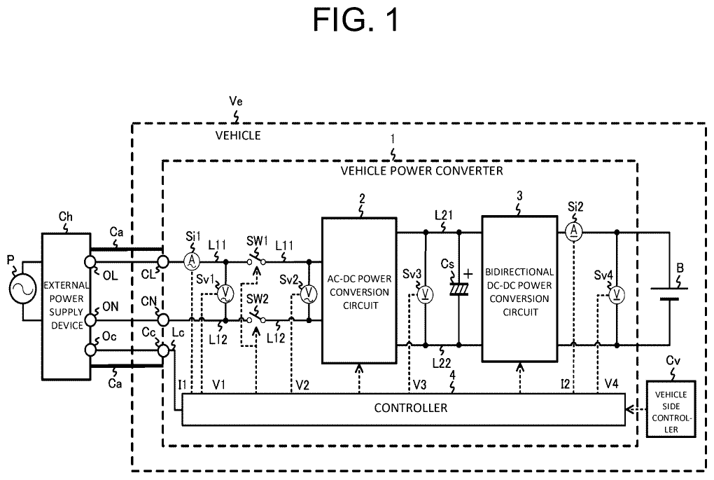

FIG. 1 is a diagram illustrating an example of a vehicle power converter according to the present embodiment.

A vehicle power converter 1 illustrated in FIG. 1 is mounted on a vehicle Ve such as an electric vehicle and a plug-in hybrid vehicle. The vehicle power converter 1 converts an alternating current power (AC power) supplied from an external power supply device Ch such as a charge station to a direct current power (DC power) corresponding to a target DC power and supplies the DC power to a battery B mounted on the vehicle Ve.

Note that the external power supply device Ch converts an AC power output from an AC power supply P to a specified AC power and supplies the specified AC power to the vehicle power converter 1. Here, the AC power supply P is an external power supply such as a commercial power supply.

In addition, the battery B is a rechargeable battery such as a lithium-ion secondary battery. The battery B serves as either a main battery for supplying a power to a driving device such as a traveling motor or an auxiliary battery for supplying a power to electrical equipment such as an air compressor and to a vehicle side controller Cv that controls driving operation of the vehicle Ve.

In the example illustrated in FIG. 1, the AC power output from the external power supply device Ch is supplied to the vehicle power converter 1 through a charging cable Ca; however, the AC power output from the external power supply device Ch may be wirelessly supplied to the vehicle power converter 1. In such a configuration, the vehicle power converter 1 includes a receiving power unit by which the AC power is wirelessly received, the receiving power unit being connected to connectors CL, CN, which will be described later.

The vehicle power converter 1 also includes the connectors CL, CN, a connector Cc, switches SW1, SW2, an AC-DC power conversion circuit 2, a bidirectional DC-DC power conversion circuit 3, a smoothing capacitor Cs, current sensors Si1, Si2, a voltage sensor Sv1 (first voltage sensor), a voltage sensor Sv2 (second voltage sensor), a voltage sensor Sv3, a voltage sensor Sv4, and a controller 4.

The AC power, which is output from the AC power supply P, is input to the connectors CL, CN through the external power supply device Ch. The connector CL is connected to one terminal of the AC-DC power conversion circuit 2 on an AC power side thereof through a connection line (live wire) L11. In addition, the connector CL is connected to one output terminal OL of the external power supply device Ch through one power line in the charging cable Ca. The connector CN is connected to the other terminal of the AC-DC power conversion circuit 2 on the AC power side thereof through a connection line (neutral wire) L12. In addition, the connector CN is connected to the other output terminal ON of the external power supply device Ch through the other power line in the charging cable Ca. The connector Cc is connected to the controller 4 through a signal line Lc. In addition, the connector Cc is connected to a terminal Oc of the external power supply device Ch through a signal line in the charging cable Ca. When the vehicle power converter 1 is connected to the external power supply device Ch through the charging cable Ca, a power is ready to be supplied from the external power supply device Ch to the vehicle power converter 1, and the vehicle power converter 1 and the external power supply device Ch can communicate with each other.

The switches SW1, SW2 are each formed of an electromagnetic relay with a normally open contact (single-pole single-throw relay). The switch SW1 is provided between the connector CL and the smoothing capacitor Cs, and the switch SW2 is provided between the connector CN and the smoothing capacitor Cs. The smoothing capacitor Cs will be described later. In the present embodiment, the switch SW1 is provided on the connection line L11 between the connector CL and the one terminal of the AC-DC power conversion circuit 2. In addition, the switch SW2 is provided on a connection line L12 between the connector CN and the other terminal of the AC-DC power conversion circuit 2. When the switches SW1, SW2 are set in an on-state, the connectors CL, CN are electrically connected to the AC-DC power conversion circuit 2 (smoothing capacitor Cs). When at least one of the switches SW1, SW2 is set in an off-state, the connectors CL, CN are electrically disconnected from the AC-DC power conversion circuit 2 (smoothing capacitor Cs). Note that one of the switches SW1, SW2 may be omitted and only one switch of them may be provided. When both switches SW1, SW2 are provided, even when one of them fails, the connectors CL, CN are electrically disconnected from the smoothing capacitor Cs by the other of them.

The AC-DC power conversion circuit 2 converts the AC power input to the connectors CL, CN to a DC power by rectifying the AC power.

The smoothing capacitor Cs is provided between the AC-DC power conversion circuit 2 and the bidirectional DC-DC power conversion circuit 3. The DC power rectified by the AC-DC power conversion circuit 2 is smoothed by the smoothing capacitor Cs and the smoothed power is output to the bidirectional DC-DC power conversion circuit 3. That is, one terminal of the smoothing capacitor Cs is connected to a connection line (positive wire) L21. The connection line L21 connects one terminal of the AC-DC power conversion circuit 2 on a DC power side thereof to one terminal of the bidirectional DC-DC power conversion circuit 3 on a side opposite to the battery B across the bidirectional DC-DC power conversion circuit 3. The other terminal of the smoothing capacitor Cs is connected to a connection line (negative wire) L22. The connection line L22 connects the other terminal of the AC-DC power conversion circuit 2 on the DC power side thereof to the other terminal of the bidirectional DC-DC power conversion circuit 3 on the side opposite to the battery B across the bidirectional DC-DC power conversion circuit 3.

The bidirectional DC-DC power conversion circuit 3 is provided between the smoothing capacitor Cs and the battery B. When the battery B is charged, the bidirectional DC-DC power conversion circuit 3 converts the DC power smoothed by the smoothing capacitor Cs to the DC power corresponding to the target DC power and supplies the DC power to the battery B.

The current sensor Si1 is formed of a Hall element, a shunt resistor, or the like. The current sensor Si1 detects a current I1 flowing through the connection line L11 and sends the detected current I1 to the controller 4.

The voltage sensor Sv1 is formed of a voltage divider including resistors, or the like. The voltage sensor Sv1 detects a voltage V1 between the connection line L11 connecting the connector CL to the switch SW1 and the connection line L12 connecting the connector CN to the switch SW2 and sends the detected voltage V1 to the controller 4.

The voltage sensor Sv2 is formed of a voltage divider including resistors, or the like. The voltage sensor Sv2 detects a voltage V2 between the connection line L11 connecting the switch SW1 to the AC-DC power conversion circuit 2 and the connection line L12 connecting the switch SW2 to the AC-DC power conversion circuit 2 and sends the detected voltage V2 to the controller 4.

The voltage sensor Sv3 is formed of a voltage divider including resistors, or the like. The voltage sensor Sv3 detects a voltage V3 across the smoothing capacitor Cs and sends the detected voltage V3 to the controller 4.

The current sensor Si2 is formed of a Hall element, a shunt resistor, or the like. The current sensor Si2 detects a current I2 flowing through the bidirectional DC-DC power conversion circuit 3 and sends the detected current I2 to the controller 4.

The voltage sensor Sv4 is formed of a voltage divider including resistors, or the like. When the battery B is charged, the voltage sensor Sv4 detects a voltage V4 output from the bidirectional DC-DC power conversion circuit 3 and sends the detected voltage V4 to the controller 4.

### <An Example of AC-DC Power Conversion Circuit 2>

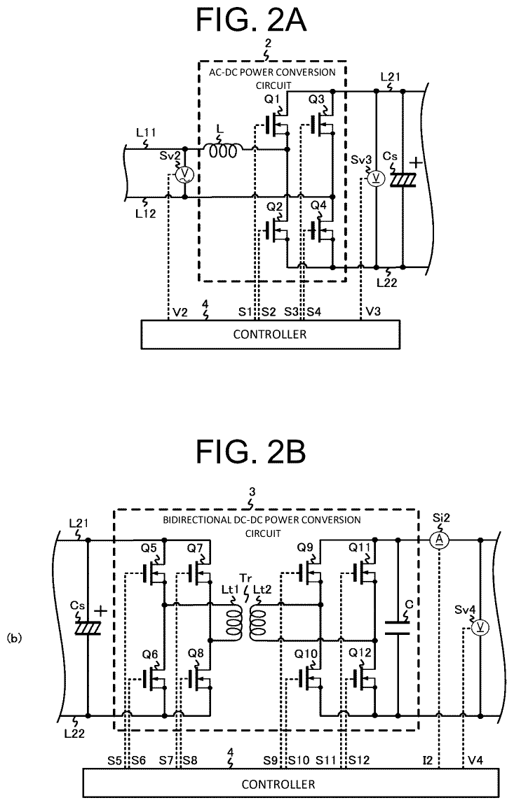

FIG. 2A is a diagram illustrating an example of the AC-DC power conversion circuit 2. Note that in FIG. 2A, the same components as those illustrated in FIG. 1 are denoted by the same reference numerals.

The AC-DC power conversion circuit 2 illustrated in FIG. 2A is a so-called totem-pole power factor correction (PFC) circuit and includes an inductor L and switching elements Q1 to Q4. Note that the switching elements Q1 to Q4 are each formed of a metal oxide semiconductor field-effect transistor (MOSFET), for example.

One terminal of the inductor L is connected to the connection line L11 and the other terminal of the inductor L is connected to a node between a source terminal of the switching element Q1 and a drain terminal of the switching element Q2. A node between a source terminal of the switching element Q3 and a drain terminal of the switching element Q4 is connected to the connection line L12. Drain terminals of the switching elements Q1, Q3 are connected to the one terminal of the smoothing capacitor Cs through the connection line L21, and source terminals of the switching elements Q2, Q4 are connected to the other terminal of the smoothing capacitor Cs through the connection line L22.

While a positive power is input to the AC-DC power conversion circuit 2 through the connection lines L11, L12 (while the AC power is a positive value), after the switching elements Q2, Q4 are turned on and the switching elements Q1, Q3 are turned off, the switching elements Q1, Q4 are turned on and the switching elements Q2, Q3 are turned off. This on-off operation is repeated in the above-described term. While a negative power is input to the AC-DC power conversion circuit 2 through the connection lines L11, L12 (while the AC power is a negative value), after the switching elements Q1, Q3 are turned on and the switching elements Q2, Q4 are turned off, the switching elements Q2, Q3 are turned on and the switching elements Q1, Q4 are turned off. This on-off operation is repeated in the above-described term. As a result, a power factor in the AC power input to the AC-DC power conversion circuit 2 is corrected and the AC power is rectified by the AC-DC power conversion circuit 2.

In addition, the AC-DC power conversion circuit 2 is a bidirectional circuit that may convert a DC power on a side of the smoothing capacitor Cs to an AC power and output the converted AC power toward the connectors CL, CN.

### <An Example of the Bidirectional DC-DC Power Conversion Circuit 3>

FIG. 2B is a diagram illustrating an example of the bidirectional DC-DC power conversion circuit 3. Note that in FIG. 2B, the same components as those illustrated in FIG. 1 are denoted by the same reference numerals.

The bidirectional DC-DC power conversion circuit 3 illustrated in FIG. 2B includes a transformer Tr, switching elements Q5 to Q8 that form a bridge circuit on a primary side of the transformer Tr, switching elements Q9 to Q12 that form a bridge circuit on a secondary side of the transformer Tr, and a capacitor C provided on a side of the battery B. Note that the switching elements Q5 to Q12 are each formed of a MOSFET, for example.

Drain terminals of the switching elements Q5, Q7 are connected to the one terminal of the smoothing capacitor Cs through the connection line L21, and source terminals of the switching elements Q6, Q8 are connected to the other terminal of the smoothing capacitor Cs through the connection line L22. A node between a source terminal of the switching element Q5 and a drain terminal of the switching element Q6 are connected to one terminal of a primary coil Lt1 of the transformer Tr, and a node between a source terminal of the switching element Q7 and a drain terminal of the switching element Q8 are connected to the other terminal of the primary coil Lt1 of the transformer Tr. Drain terminals of the switching elements Q9, Q11 are connected to one terminal of the capacitor C, and source terminals of the switching element Q10, Q12 are connected to the other terminal of the capacitor C. A node between a source terminal of the switching element Q9 and a drain terminal of the switching element Q10 are connected to one terminal of a secondary coil Lt2 of the transformer Tr, and a node between a source terminal of the switching element Q11 and a drain terminal of the switching element Q12 are connected to the other terminal of the secondary coil Lt2 of the transformer Tr. The one terminal of the capacitor C is connected to a positive terminal of the battery B illustrated in FIG. 1 and the other terminal of the capacitor C is connected to a negative terminal of the battery B.

Note that a configuration of the bidirectional DC-DC power conversion circuit 3 is not limited to a circuit configuration illustrated in FIG. 2B, as long as the bidirectional DC-DC power conversion circuit 3 converts the DC power smoothed by the smoothing capacitor Cs to the DC power corresponding to the target DC power and supplies the DC power to the battery B, and also converts the DC power output from the battery B to a specified DC power and supplies the specified DC power to the smoothing capacitor Cs.

### <Configuration of Controller 4>

The controller 4 illustrated in FIG. 1 is formed of a processor or a programmable device such as a field programmable gate array (FPGA) and a programmable logic device (PLD). The controller 4 controls operation of each of the AC-DC power conversion circuit 2, the bidirectional DC-DC power conversion circuit 3, and the switches SW1, SW2. Note that the operation of each of the AC-DC power conversion circuit 2 and the switches SW1, SW2 may be controlled by a controller other than the controller 4. In this case, the controller 4 cooperates with the other controller to control the operation of the bidirectional DC-DC power conversion circuit 3.

### <Operation of Controller 4>

1) In advance, the connectors CL, CN are electrically disconnected from the smoothing capacitor Cs by the switches SW1, SW2. Firstly, when the controller 4 determines that the vehicle power converter 1 is connected to the AC power supply P through the external power supply device Ch, the controller 4 controls the operation of the bidirectional DC-DC power conversion circuit 3 while keeping a connection state between the smoothing capacitor Cs and the connectors CL, CN in the disconnected state by the switches SW1, SW2, so that the power output from the battery B is supplied to the smoothing capacitor Cs to pre-charge the smoothing capacitor Cs. That is, when the controller 4 determines that the vehicle power converter 1 is connected to the external power supply device Ch, the controller 4 executes battery charging preparation operation. The battery charging preparation operation is operation in which after the controller 4 controls the operation of the bidirectional DC-DC power conversion circuit 3 while keeping the connection state between the smoothing capacitor Cs and the connectors CL, CN in the disconnected state by the switches SW1, SW2 so that the power output from the battery B is supplied to the smoothing capacitor Cs, the controller 4 causes a connection state of each of the switches SW1, SW2 to transition from a disconnected state to a connected state by turning the switches SW1, SW2 from off to on. Note that the controller 4 keeps the connection state between the smoothing capacitor Cs and the connectors CL, CN in the disconnected state by the switches SW1, SW2 from an end of the previous charging of the battery B until an end of the pre-charging of the smoothing capacitor Cs. In addition, a maximum current flowing from the battery B into the smoothing capacitor Cs through the bidirectional DC-DC power conversion circuit 3 when the smoothing capacitor Cs is pre-charged is, for example, a rated current of the smoothing capacitor Cs or less.
2) Next, when the pre-charging of the smoothing capacitor Cs ends, the controller 4 causes a connection state between the AC power supply P and the vehicle power converter 1 to transition from a disconnected state to a connected state by turning both the switches SW1, SW2 on (the battery charging preparation operation ends).
3) Next, the controller 4 controls the operation of each of the AC-DC power conversion circuit 2 and the bidirectional DC-DC power conversion circuit 3 so that the DC power corresponding to the target DC power that is sent from the vehicle side controller Cv to the controller 4 is output to the battery B.
4) Then, when the target DC power that is sent from the vehicle side controller Cv to the controller 4 reaches zero or when an instruction for ending the charging of the battery B is sent from the vehicle side controller Cv to the controller 4, the controller 4 stops the operation of each of the AC-DC power conversion circuit 2 and the bidirectional DC-DC power conversion circuit 3, and causes the connection state between the smoothing capacitor Cs and the connectors CL, CN to transition from the connected state to the disconnected state by the switches SW1, SW2.
   <Example of Operation of Controller 4 when Controller 4 Determines that Vehicle Power Converter 1 is Connected to AC Power Supply P Through External Power Supply Device Ch>

When the controller 4 detects a signal passing through the signal line in the charging cable Ca and the signal line Lc, the controller 4 determines that the vehicle power converter 1 is connected to the AC power supply P through the external power supply device Ch. Note that the above-described signal is, for example, a PISW signal (Proximity Detection Signal). When the vehicle power converter 1 is connected to the external power supply device Ch through the charging cable Ca, the PISW signal is input to a PISW terminal on a side of the vehicle power converter 1 and detected by the controller 4. The above-described signal may be, for example, a CPLT (Control Pilot Line) signal. When the vehicle power converter 1 is connected to the external power supply device Ch through the charging cable Ca, the CPLT signal is input to a CPLT terminal on the side of the vehicle power converter 1 and detected by the controller 4. Note that the wording of “determines that the vehicle power converter 1 is connected to the AC power supply P” includes a state in which the vehicle power converter 1 is actually connected to the AC power supply P.

Alternatively, when the controller 4 receives an instruction for starting the charging of the battery B, which is sent from the vehicle side controller Cv, the controller 4 determines that the vehicle power converter 1 is connected to the AC power supply P through the external power supply device Ch. Note that the vehicle side controller Cv sends the instruction for starting the charging of the battery B to the controller 4 based on user's operation, a remaining capacity of the battery B, or the like.

Alternatively, in a case where the AC power is wirelessly output to the vehicle power converter 1 from the external power supply device Ch, when communication for preparing the charging is established between the controller 4 and the external power supply device Ch, the controller 4 determines that the vehicle power converter 1 is connected to the AC power P through the external power supply device Ch.

Alternatively, when the controller 4 receives information, from the vehicle side controller Cv, that the vehicle Ve approaches the external power supply device Ch, the controller 4 determines that the vehicle power converter 1 is connected to the AC power supply P through the external power supply device Ch. Note that when the vehicle side controller Cv determines that the vehicle Ve approaches the external power supply device Ch using a signal of a global positioning system (GPS) mounted on the vehicle Ve, the vehicle side controller Cv sends the information that the vehicle Ve approaches the external power supply device Ch to the controller 4.

Alternatively, the controller 4 determines that the vehicle power converter 1 is connected to the AC power supply P through the external power supply device Ch in the following cases: after a first case where an operation or an instruction by which a cover provided on an outer surface of the vehicle Ve and covering the connectors CL, CN is opened is performed, or a sensor, which is not illustrated, detects such operation of the cover, the controller 4 receives the information from the vehicle side controller Cv; and a second case where after the sensor, which is not illustrated, detects that a driver, or the like approaches the connectors CL, CN with a wireless key, the controller 4 receives the information from the vehicle side controller Cv.

Alternatively, when the voltage sensor Sv1 detects an AC voltage V1 that is applied by the external power supply device Ch, the controller 4 determines that the vehicle power converter 1 is connected to the AC power supply P through the external power supply device Ch.

<Example of Operation of Controller 4 when Pre-Charging of Smoothing Capacitor Cs Ends>

In pre-charging of the smoothing capacitor Cs, when the voltage V3 detected by the voltage sensor Sv3 is a threshold voltage Vth3 or more, the controller 4 determines that the smoothing capacitor Cs is sufficiently charged (the smoothing capacitor Cs is filled with electric charge), and causes the connection state between the smoothing capacitor Cs and the connectors CL, CN to transition from the disconnected state to the connected state by the switches SW1, SW2. Note that for example, when the AC power is output from the external power supply device Ch to the vehicle power converter 1, the threshold voltage Vth3 is defined as a peak voltage of the AC voltage between the connection line L11 and the connection line L12 or the maximum voltage of the DC voltage between the connection line L21 and the connection line L22. The voltage threshold Vth3 may be determined in advance, may be determined or estimated from a value of the voltage sensor Sv1, or may be set to a value corresponding to the voltage output from the connected external power supply device Ch if the output voltage have been already obtained.

Alternatively, in pre-charging of the smoothing capacitor Cs, when the current flowing from the battery B into the smoothing capacitor Cs and detected by the current sensor Si2 is a threshold current or less, the controller 4 determines that the smoothing capacitor Cs is sufficiently charged, and causes the connection state between the smoothing capacitor Cs and the connectors CL, CN to transition from the disconnected state to the connected state by the switches SW1, SW2. Alternatively, a current sensor connected in series to the smoothing capacitor Cs may be provided and the current flowing from the battery B into the smoothing capacitor Cs may be detected by the current sensor. Note that a value of the threshold current is, for example, set to zero. Alternatively, the current flowing from the battery B into the smoothing capacitor Cs may be accumulated, and when the accumulated current amount exceeds a specified threshold current, the controller 4 may determines that the smoothing capacitor Cs is sufficiently charged and causes the connection state between the smoothing capacitor Cs and the connectors CL, CN to transition from the disconnected state to the connected state by the switches SW1, SW2.

Alternately, in the battery charging preparation operation, when a specified time t has elapsed since the start of the supply of the power from the battery B to the smoothing capacitor Cs, the controller 4 determines that the smoothing capacitor Cs is sufficiently charged, and causes the connection state between the smoothing capacitor Cs and the connectors CL, CN to transition from the disconnected state to the connected state by turning the switches SW1, SW2 from off to on. Here, the specified time t is equal to or longer than a time required for the voltage across the smoothing capacitor Cs to reach a voltage such that the current flowing from the AC-DC power conversion circuit 2 to the smoothing capacitor Cs when the connection state between the smoothing capacitor Cs and the connectors CL, CN is transitioned to the connected state by the switches SW1, SW2 is equal to or less than an allowable current of the smoothing capacitor Cs. In addition, the specified time t is equal to or shorter than a time required for the voltage across the smoothing capacitor Cs to reach the peak voltage of the AC power input from the external power supply device Ch or the voltage of the DC power supplied from the AC-DC power conversion circuit 2. The specified time t may be determined by an experiment in advance, or may be calculated based on the voltage across the battery B. Due to such a management of the battery charging preparation operation based on time, the time required from the start of the supply of the power from the battery B to the smoothing capacitor Cs until the connection state between the smoothing capacitor Cs and the connectors CL, CN is transitioned from the disconnected state to the connected state by the switches SW1, SW2 is shortened by a certain time, as compared with a case where the voltage across the smoothing capacitor Cs or the current flowing into the smoothing capacitor Cs is obtained and whether the smoothing capacitor Cs is sufficiently charged is determined based on the obtained voltage or current. Here, the certain time is a time required to convert analog values detected by the voltage sensor and the current sensor to digital values. Furthermore, this management prevents the smoothing capacitor Cs from being damaged when the connection state between the smoothing capacitor Cs and the connectors CL, CN is transitioned from the disconnected state to the connected state by the switches SW1, SW2. That is, the time required from when the vehicle power converter 1 is connected to the AC power supply P through the external power supply device Ch until the charging of the battery B is started is shortened.

In addition, the controller 4 may be configured such that the controller 4 changes the specified time t (the threshold voltage Vth3, the threshold current, the specified threshold current in the accumulated current amount) in accordance with the voltage V1 detected by the voltage sensor Sv1. For example, specifically, the controller 4 may be configured such that the controller 4 makes the specified time t shorter as the voltage V1 decreases. Usually, when the output voltage of the external power supply device Ch is relatively low, the current flowing from the external power supply device Ch into the vehicle power converter 1 is relatively small. For this reason, even when the specified time t is made shorter, the current flowing from the external power supply device Ch into the smoothing capacitor Cs when the connection state between the smoothing capacitor Cs and the connectors CL, CN is transitioned from the disconnected state to the connected state by the switches SW1, SW2 is relatively small. Accordingly, the smoothing capacitor Cs is charged only as much as needed in accordance with the output voltage of the external power supply device Ch, so that the time required from the start of the supply of the power from the battery B to the smoothing capacitor Cs until the connection state between the smoothing capacitor Cs and the connectors CL, CN is transitioned from the disconnected state to the connected state by the switches SW1, SW2 is shortened, as compared with a case where the specified voltage, the specified current, or the specified time are determined in accordance with the assumed maximum output voltage of the external power supply device Ch. That is, the time required from when the vehicle power converter 1 is connected to the AC power supply P through the external power supply device Ch until the charging of the battery B is started is shortened.

<Example of Operation of Controller 4 when Determining Whether at Least One of Switches SW1, SW2 is Fused>

When the AC power is output from the AC power supply P to the vehicle power converter 1 through the external power supply device Ch and the connection state between the smoothing capacitor Cs and the connectors CL, CN is kept in the disconnected state by the switches SW1, SW2, the controller 4 determines that at least one of the switches SW1, SW2 is fused in a case where the voltage V1 detected by the voltage sensor Sv1 is a threshold voltage Vth1 (first threshold voltage) or more and the voltage V2 detected by the voltage sensor Sv2 is a threshold voltage Vth2 (second threshold voltage) or more. This makes it possible to determine whether at least one of the switches SW1, SW2 is fused. Note that when only one of the switches SW1, SW2 is provided in the vehicle power converter 1, the controller 4 determines the switch is fused in the case where the voltage V1 detected by the voltage sensor Sv1 is the threshold voltage Vth1 or more and the voltage V2 detected by the voltage sensor Sv2 is the threshold voltage Vth2 or more.

<Example of Operation of Controller 4 after Connection State Between Smoothing Capacitor Cs and Connectors CL, CN is Transitioned from Disconnected State to Connected State by Switches SW1, SW2>

When the battery B is charged, the controller 4 controls the driving of the switching elements Q1 to Q4 by outputting driving signals S1 to S4 using the current I1 detected by the current sensor Si1, the voltage V2 detected by the voltage sensor Sv2, and the voltage V3 detected by the voltage sensor Sv3. Here, the controller 4 controls the driving of the switching elements Q1 to Q4 so that a phase different between the AC current input to the AC-DC power conversion circuit 2 and the AC voltage input to the AC-DC power conversion circuit 2 approaches zero, that is, the power factor in the AC power input to the AC-DC power conversion circuit 2 approaches one. With this control, the power with the corrected power factor, which has been rectified by the AC-DC power conversion circuit 2, is output to the smoothing capacitor Cs.

In addition, when the battery B is charged, the controller 4 controls the driving of the switching elements Q5 to Q8 by outputting driving signals S5 to S8 and controls the driving of the switching elements Q9 to Q12 by outputting driving signals S9 to S12 so that the DC power supplied from the bidirectional DC-DC power conversion circuit 3 to the battery B follows the target DC power. Note that the target DC power is, for example, set based on the voltage across the battery B when a constant current charging control is switched to a constant voltage charging control or based on the current flowing through the battery B when the constant voltage charging control ends. For example, a duty ratio of each of the driving signals S5 to S12 is set to 50[%]. In addition, the driving signal S5 is synchronized with the driving signal S8, the driving signal S6 is synchronized with the driving signal S7, the driving signal S9 is synchronized with the driving signal S12, and the driving signal S10 is synchronized with the driving signal S11. A phase of the driving signal S5 and S8 is shifted by 180 degrees from a phase of the driving signal S6 and S7, and a phase of the driving signal S9 and S12 is shifted by 180 degrees from a phase of the driving signal S10 and S11. A dead time is provided between a rise time of the driving signal S5 and a fall time of the driving signal S6 and between a fall time of the driving signal S5 and a rise time of the driving signal S6. A dead time is provided between a rise time of the driving signal S7 and a fall time of the driving signal S8 and between a fall time of the driving signal S7 and a rise time of the driving signal S8. A dead time is provided between a rise time of the driving signal S9 and a fall time of the driving signal S10 and between a fall time of the driving signal S9 and a rise time of the driving signal S10. A dead time is provided between a rise time of the driving signal S11 and a fall time of the driving signal S12 and between a fall time of the driving signal S11 and a rise time of the driving signal S12.

<Example of Operation of Controller 4 when AC Power is Output from Connectors CL, CN>

When the controller 4 receives an instruction for converting the power supplied from the battery B to the AC power and outputting the AC power to an outside of the vehicle power converter 1 through the connectors CL, CN from a user, the controller 4 controls operation of each of the AC-DC power conversion circuit 2 and the bidirectional DC-DC power conversion circuit 3 so that the DC power output from the battery B is converted to the AC power and the converted AC power is output to the outside of the vehicle power converter 1 through the connectors CL, CN.

The following will describe an effect of the vehicle power converter 1 according to the present embodiment.

### First Effect

When the power is supplied from the AC power supply P to the vehicle power converter 1, for example, there may be a case where the vehicle power converter 1 is connected to the AC power supply P through the external power supply device Ch and the external power supply device Ch does not have a function for controlling a power output timing (for example, a charging control method of the external power supply device Ch is non-standard or has only the MODE 1). In this case, the AC power may be supplied from the AC power supply P to the vehicle power converter 1 at a time when the vehicle power converter 1 is connected to the external power supply device Ch, that is, at a time when the connector of the charge station is inserted into the vehicle Ve.

Here, in the vehicle power converter 1 of the present embodiment, when the controller 4 determines that the vehicle power converter 1 is connected to the AC power supply P through the external power supply device Ch, the controller 4 executes the battery charging preparation operation. Specifically, the connection state between the smoothing capacitor Cs and the connectors CL, CN is kept in the disconnected state by the switches SW1, SW2, which prohibits the supply of the power to the smoothing capacitor Cs. In addition, in the battery charging preparation operation, the smoothing capacitor Cs is pre-charged by supplying the power from the battery B to the smoothing capacitor Cs. When the pre-charging of the smoothing capacitor Cs has been completed, the controller 4 causes the connection state between the smoothing capacitor Cs and the connectors CL, CN to transition from the disconnected state to the connected state by the switches SW1, SW2, which allows the supply of the power from the AC power supply P to the smoothing capacitor Cs.

As a result, even when the external power supply device Ch does not have the function for controlling the power output timing, it is suppressed that the power is supplied from the AC power supply P to the smoothing capacitor Cs through the external power supply device Ch before the smoothing capacitor Cs is sufficiently charged. This suppresses that a relatively large inrush current flows into the smoothing capacitor Cs. In addition, a resistor need not be provided in order to limit the inrush current flowing into the smoothing capacitor Cs, so that an increase of manufacturing costs of the vehicle power converter 1 is suppressed.

### Second Effect

In pre-charging of the smoothing capacitor Cs, when the voltage V3 detected by the voltage sensor Sv3 is the threshold voltage Vth3 or more, the controller 4 may determine that the smoothing capacitor Cs is sufficiently charged (the smoothing capacitor Cs is filled with electric charge) and cause the connection state between the smoothing capacitor Cs and the connectors CL, CN to transition from the disconnected state to the connected state by the switches SW1, SW2.

This control surely suppresses that a relatively large inrush current flows into the smoothing capacitor Cs.

### Third Effect

In the battery charging preparation operation, when the specified time t has elapsed since the start of the supply of the power from the battery B to smoothing capacitor Cs, the controller 4 may cause the connection state between the smoothing capacitor Cs and the connectors CL, CN to transition from the disconnected state to the connected state. The specified time t is equal to or longer than the time required for the voltage across the smoothing capacitor Cs to reach the voltage such that the current flowing from the AC-DC power conversion circuit 2 to the smoothing capacitor Cs when the connection state between the smoothing capacitor Cs and the connectors CL, CN is transitioned to the connected state by the switches SW1, SW2 is equal to or less than the allowable current of the smoothing capacitor Cs. In addition, the specified time t is equal to or shorter than the time required for the voltage across the smoothing capacitor Cs to reach the peak voltage of the AC power input from the external power supply device Ch or the voltage of the DC power supplied from the AC-DC power conversion circuit 2.

Due to such a management of the battery charging preparation operation based on time, the time required from the start of the supply of the power from the battery B to the smoothing capacitor Cs until the connection state between the smoothing capacitor Cs and the connectors CL, CN is transitioned from the disconnected state to the connected state by the switches SW1, SW2 is shortened, as compared with the case where the voltage across the smoothing capacitor Cs or the current flowing into the smoothing capacitor Cs is obtained and whether the smoothing capacitor Cs is sufficiently charged is determined based on the obtained voltage or current. Furthermore, this management prevents the smoothing capacitor from being damaged when the connection state between the smoothing capacitor Cs and the connectors CL, CN is transitioned from the disconnected state to the connected state by the switches SW1, SW2. That is, the time required from when the vehicle power converter 1 is connected to the AC power supply P through the external power supply device Ch until the charging of the battery B is started is shortened.

### Fourth Effect

The specified time t (the threshold voltage Vth3, the threshold current, or the specified threshold current in the accumulated current amount) may be changed in accordance with the voltage V1 detected by the voltage sensor Sv1.

For example, specifically, the specified time t may be made shorter as the voltage V1 decreases.

Usually, as the output value of the external power supply device Ch is relatively low, the current flowing from the external power supply device Ch to the vehicle power converter 1 is relatively small. For this reason, the time from the start of the supply of power from the battery B to the smoothing capacitor Cs until the connection state between the smoothing capacitor Cs and the connectors CL, CN is transitioned from the disconnected state to the connected state by the switches SW1, SW2 is shortened. That is, the time required from when the vehicle power converter 1 is connected to the AC power supply P through the external power supply device Ch until the charging of the battery B is started is shortened.

### Fifth Effect

The AC-DC power conversion circuit 2 is the bidirectional circuit that may convert the DC power on the side of the smoothing capacitor Cs to the AC power and output the converted AC power toward the connectors CL, CN. When the controller 4 receives the instruction for converting the power supplied from the battery B to the AC power and outputting the AC power to the outside of the vehicle power converter 1 through the connectors CL, CN from the user, the controller 4 controls the operation of each of the AC-DC power conversion circuit 2 and the bidirectional DC-DC power conversion circuit 3 so that the DC power output from the battery B is converted to the AC power and the converted AC power is output to the outside of the vehicle power converter 1 through the connectors CL, CN. Accordingly, the vehicle power converter is usable not only for charging but also as a supply source of the AC power.

### Sixth Effect

The vehicle power converter 1 includes the switches SW1, SW2, the voltage sensor Sv1, and the voltage sensor Sv2. With this configuration, when the AC power is output from the AC power supply P to the vehicle power converter 1 through the external power supply device Ch and the connection state between the smoothing capacitor Cs and the connectors CL, CN is kept in the disconnected state by the switches SW1, SW2, the controller 4 determines that at least one of the switches SW1, SW2 is fused in the case where the voltage V1 detected by the voltage sensor Sv1 is the threshold voltage Vth1 (first threshold voltage) or more and the voltage V2 detected by the voltage sensor Sv2 is the threshold voltage

Vth2 (second threshold voltage) or more. This makes it possible to determine whether at least one of the switches SW1, SW2 is fused.

### Modified Example 1

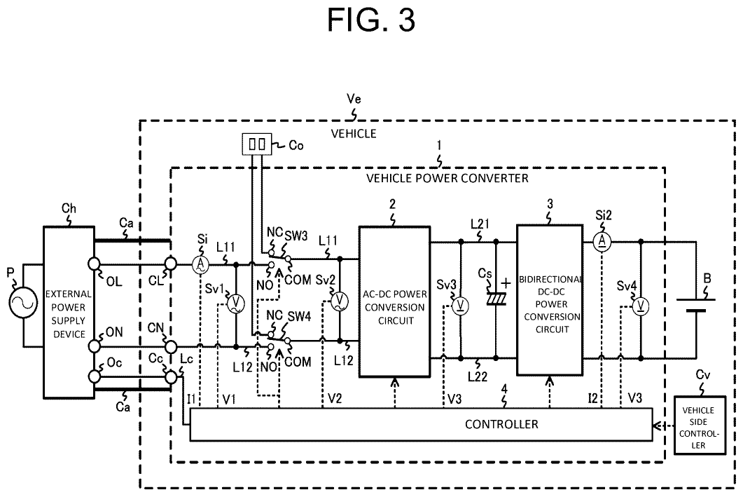

FIG. 3 is a diagram illustrating a modified example 1 of the vehicle power converter 1 according to the present embodiment. Note that in FIG. 3, the same components as those illustrated in FIG. 1 are denoted by the same reference numerals, and the description of them will be omitted. In addition, a vehicle compartment power feed portion Co illustrated in FIG. 3 is an outlet terminal that is provided in the vehicle Ve and from which the AC power is supplied to a vehicle compartment. A load such as an electric appliance, which is not illustrated, is connected to the vehicle compartment power feed portion Co. When the AC power is supplied from the vehicle power converter 1 to the vehicle compartment power feed portion Co in a state in which a load is connected to the vehicle compartment power feed portion Co, the AC power is supplied to the load.

The vehicle power converter 1 illustrated in FIG. 3 is different from the vehicle power converter 1 illustrated in FIG. 1 in that switches SW3, SW4 are provided instead of the switches SW1, SW2.

For example, the switches SW3, SW4 are each formed of an electromagnetic relay with a changeover contact (single-pole double-throw relay). A terminal COM of each of the switches SW3, SW4 is connected to the AC-DC power conversion circuit 2. A terminal NC of each of the switches SW3, SW4 is connected to the vehicle compartment power feed portion Co. A terminal NO of the switch SW3 is connected to the connector CL and a terminal NO of the switch SW4 is connected to the connector CN.

When the terminal COM of each of the switches SW3, SW4 is connected to the corresponding terminal NC of the switches SW3, SW4, the AC-DC power conversion circuit 2 is connected to the vehicle compartment power feed portion Co. In this case, the connection state between the smoothing capacitor Cs and the connectors CL, CN is transitioned to the disconnected state by the switches SW3, SW4. Note that even when the terminal COM of at least one of the switches SW3, SW4 is connected to the corresponding terminal NC, the connection state between the smoothing capacitor Cs and the connectors CL, CN is also referred to as the disconnected state.

When the terminal COM of each of the switches SW3, SW4 is connected to the corresponding terminal NO of the switches SW3, SW4, the AC-DC power conversion circuit 2 is connected to the connectors CL, CN. In this case, the connection state between the smoothing capacitor Cs and the connectors CL, CN is transitioned to the connected state by the switches SW3, SW4.

<Example of Operation of Controller 4 when Battery B is Charged>

Firstly, when the controller 4 determines that the vehicle power converter 1 is connected to the AC power supply P through the external power supply device Ch, the controller 4 controls the switches SW3, SW4 so that the terminal COM of at least one of the switches SW3, SW4 is connected to the terminal NC. In this case, the connection state between the smoothing capacitor Cs and the connectors CL, CN is transitioned to the disconnected state by the switches SW3, SW4. In addition, the controller 4 controls the operation of the bidirectional DC-DC power conversion circuit 3 to pre-charge the smoothing capacitor Cs. Note that stopping the operation of the AC-DC power conversion circuit 2 when the smoothing capacitor Cs is pre-charged prevents the AC power output from the AC-DC power conversion circuit 2 from being output to the outside of the vehicle power converter 1 through the vehicle compartment power feed portion Co.

Next, when the pre-charging of the smoothing capacitor Cs has been completed, the controller 4 controls the switches SW3, SW4 so that the terminal COM of each of the switches SW3, SW4 is connected to the corresponding terminal NO of the switches SW3, SW4. In this case, the connection state between the smoothing capacitor Cs and the connectors CL, CN is transitioned to the connected state by the switches SW3, SW4.

Then, the controller 4 controls the operation of each of the AC-DC power conversion circuit 2 and the bidirectional DC-DC power conversion circuit 3 so that the AC power output from the external power supply device Ch is converted to the DC power corresponding to the target DC power and the DC power is supplied to the battery B.

<Example of Operation of Controller 4 when Power is Supplied to Vehicle Compartment Power Feed Portion Co>

Firstly, when the controller 4 receives an instruction for supplying a power to the vehicle compartment power feed portion Co, which is sent from the vehicle side controller Cv, the controller 4 controls the switches SW3, SW4 so that the terminal COM of each of the switches SW3, SW4 are connected to the corresponding terminal NC of the switches SW3, SW4.

Then, the controller 4 controls the operation of each of the AC-DC power conversion circuit 2 and the bidirectional DC-DC power conversion circuit 3 so that the DC power output from the battery B is converted to the AC power and the AC power is supplied to the vehicle compartment power feed portion Co.

The vehicle power converter 1 according to the modified example 1 provides the same effects as the first to sixth effects. The vehicle power converter 1 according to the modified example 1 also provides the following seventh effect.

### Seventh Effect

The vehicle Ve includes the vehicle compartment power feed portion Co that supplies the AC power to the vehicle compartment, and the AC-DC power conversion circuit 2 is the bidirectional circuit that may convert the DC power on the side of the smoothing capacitor Cs to the AC power and output the converted AC power toward the connectors. The switches SW3, SW4 are provided instead of the switches SW1, SW2 between the AC-DC power conversion circuit 2 and the connectors CL, CN and connect the AC-DC power conversion circuit 2 to the connectors CL, CN or connect the AC-DC power conversion circuit 2 to the vehicle compartment power feed portion Co. Accordingly, the switches SW3, SW4 are also used as the switches SW1, SW2, which prevents an increase of the manufacturing costs of the vehicle power converter 1 that has a function for supplying the power to the vehicle compartment power feed portion Co.

### Modified Example 2-1

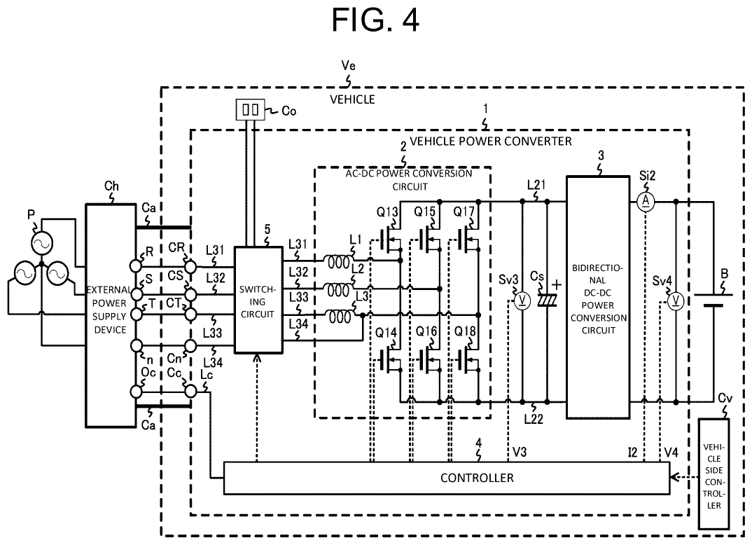

FIG. 4 is a diagram illustrating a modified example 2-1 of the vehicle power converter 1 according to the present embodiment. Note that in FIG. 4, the same components as those illustrated in FIG. 3 are denoted by the same reference numerals, and the description of them will be omitted.

The vehicle power converter 1 illustrated in FIG. 4 is different from the vehicle power converter 1 illustrated in FIG. 3 in that a three-phase AC power output from the external power supply device Ch is converted to the DC power corresponding to the target DC power and the DC power is supplied to the battery B. Here, the AC power supply P in the modified example 2-1 is a three-phase AC power supply. Note that the external power supply device Ch converts an R-phase AC power of the three-phase AC power output from the AC power supply P to a specified AC power and outputs the specified AC power from a terminal R, converts an S-phase AC power of the three-phase AC power output from the AC power supply P to a specified AC power and outputs the specified AC power from a terminal S, and converts an T-phase AC power of the three-phase AC power output from the AC power supply P to a specified AC power and outputs the specified AC power from a terminal T. Furthermore, a terminal n of the external power supply device Ch is connected to a neutral point of the AC power supply P.

The vehicle power converter 1 illustrated in FIG. 4 includes connectors CR, CS, CT, Cn instead of the connectors CL, CN and further includes a switching circuit 5.

When the vehicle power converter 1 is connected to the external power supply device Ch through the charging cable Ca, the connectors CR, CS, CT, Cn of the vehicle power converter 1 are connected to the terminals R, S, T, n of the external power supply device Ch, respectively.

The AC-DC power conversion circuit 2 illustrated in FIG. 4 includes inductors L1 to L3 and switching elements Q13 to Q18. Note that the switching elements Q13 to Q18 are each formed of a MOSFET, for example.

One terminal of the inductor L1 is connected to a connection line L31, and the other terminal of the inductor L1 is connected to a node between a source terminal of the switching element Q13 and a drain terminal of the switching element Q14. One terminal of the inductor L2 is connected to a connection line L32, and the other terminal of the inductor L2 is connected to a node between a source terminal of the switching element Q15 and a drain terminal of the switching element Q16. One terminal of the inductor L3 is connected to a connection line L33, and the other terminal of the inductor L3 is connected to a node between a source terminal of the switching element Q17 and a drain terminal of the switching element Q18.

In addition, the AC-DC power conversion circuit 2 is the bidirectional circuit that may convert the DC power on the side of the smoothing capacitor Cs to a single-phase AC power and output the single-phase AC power toward the connectors CR, Cn (the vehicle compartment power feed portion Co, which will be described later).

The controller 4 controls operation of the switching circuit 5 so as to switch between a state in which the power output from the external power supply device Ch is ready to be supplied to the battery B and a state in which the power output from the battery B is ready to be supplied to the vehicle compartment power feed portion Co.

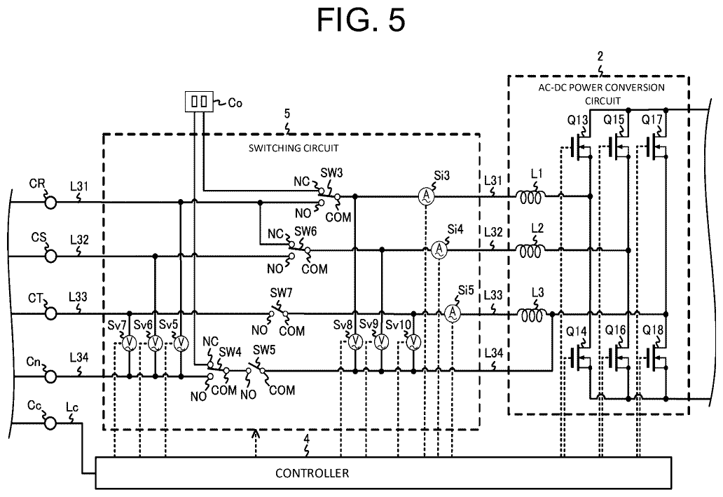

FIG. 5 is a diagram illustrating an example of the switching circuit 5 illustrated in FIG. 4.

The switching circuit 5 illustrated in FIG. 5 includes the switches SW3, SW4, switches SW5 to SW7, voltage sensors Sv5 to Sv10, and current sensors Si3 to Si5.

The switch SW3 is provided on the connection line L31. Specifically, the terminal COM, the terminal NC, and the terminal NO of the switch SW3 are connected to the inductor L1, the vehicle compartment power feed portion Co, and the connector CR, respectively. That is, the switch SW3 connects the inductor L1 to the connector CR or the vehicle compartment power feed portion Co.

The switches SW4, SW5 are provided on a connection line L34 that connects the connector Cn and a node between the switching elements Q17, Q18. Specifically, the terminal COM, the terminal NC, and the terminal NO of the switch SW4 are connected to a terminal NO of the switch SW5, the vehicle compartment power feed portion Co, and the connector Cn, respectively. Here, the switch SW5 is formed of an electromagnetic relay with a normally open contact and a terminal COM of the switch SW5 is connected to the node between the switching elements Q17, Q18. That is, the switch SW4 connects the node between the switching elements Q17, Q18 to the connector Cn or the vehicle compartment power feed portion Co.

The switch SW6 is provided on the connection line L32. Specifically, the switch SW6 is formed of an electromagnetic relay with a changeover contact. A terminal COM, a terminal NC, and a terminal NO of the switch SW6 are connected to the inductor L2, the connector CR, and the connector CS, respectively. That is, the switch SW6 connects the inductor L2 to the connector CR or the connector CS.

The switch SW7 is provided on the connection line L33. Specifically, the switch SW7 is formed of an electromagnetic relay with a normally open contact. A terminal COM and a terminal NO of the switch SW7 are connected to the inductor L3 and the connector CT, respectively.

One terminal of the voltage sensor Sv5 is connected between the switch SW3 and the connector CR, and the other terminal of the voltage sensor Sv5 is connected between the switch SW4 and the connector Cn. One terminal of the voltage sensor Sv6 is connected between the switch SW6 and the connector CS, and the other terminal of the voltage sensor Sv6 is connected between the switch SW4 and the connector Cn. One terminal of the voltage sensor Sv7 is connected between the switch SW7 and the connector CT, and the other terminal of the voltage sensor Sv7 is connected between the switch SW4 and the connector Cn. The voltage sensors Sv5, Sv6, Sv7 measure a voltage between the connection line L31 and the connection line L34, a voltage between the connection line L32 and the connection line L34, and a voltage between the connection line L33 and the connection line L34, respectively. In addition, one terminal of the voltage sensor Sv8 is connected between the switch SW3 and the AC-DC power conversion circuit 2, and the other terminal of the voltage sensor Sv8 is connected between the switch SW5 and the AC-DC power conversion circuit 2. One terminal of the voltage sensor Sv9 is connected between the switch SW6 and the AC-DC power conversion circuit 2, and the other terminal of the voltage sensor Sv6 is connected between the switch SW5 and the AC-DC power conversion circuit 2. One terminal of the voltage sensor Sv10 is connected between the switch SW7 and the AC-DC power conversion circuit 2, and the other terminal of the voltage sensor Sv10 is connected between the switch SW5 and the AC-DC power conversion circuit 2. The voltage sensors Sv8, Sv9, Sv10 measure a voltage between the connection line L31 and the connection line L34, a voltage between the connection line L32 and the connection line L34, and a voltage between the connection line L33 and the connection line L34, respectively. In addition, current sensors Si3, Si4, Si5 are provided on the connection line L31, L32, L33, respectively. The current sensors Si3, Si4, Si5 measure a current flowing through an inductor L1, a current flowing through an inductor L2, and a current flowing through an inductor L3, respectively.

Note that the connection of the voltage sensors Sv5 to Sv10 is not limited to the above-described example, and the connection may be as follows: one terminal of the voltage sensor Sv5 is connected between the switch SW3 and the connector CR, and the other terminal of the voltage sensor Sv5 is connected between the switch SW6 and the connector CS; one terminal of the voltage sensor Sv6 is connected between the switch SW6 and the connector CS, and the other terminal of the voltage sensor Sv6 is connected between the switch SW7 and the connector CT; one terminal of the voltage sensor Sv7 is connected between the switch SW7 and the connector CT, and the other terminal of the voltage sensor Sv7 is connected between the switch SW3 and the connector CR; the voltage sensors Sv5, Sv6, Sv7 measure a voltage between the connection line L31 and the connection line L32, a voltage between the connection line L32 and the connection line L33, and a voltage between the connection line L33 and the connection line L31, respectively; one terminal of the voltage sensor Sv8 is connected between the switch SW3 and the AC-DC power conversion circuit 2, and the other terminal of the voltage sensor Sv8 is connected between the switch SW6 and the AC-DC power conversion circuit 2; one terminal of the voltage sensor Sv9 is connected between the switch SW6 and the AC-DC power conversion circuit 2, and the other terminal of the voltage sensor Sv9 is connected between the switch SW7 and the AC-DC power conversion circuit 2; one terminal of the voltage sensor Sv10 is connected between the switch SW7 and the AC-DC power conversion circuit 2, and the other terminal of the voltage sensor Sv10 is connected between the switch SW3 and the AC-DC power conversion circuit 2; the voltage sensors Sv8, Sv9, Sv10 measure a voltage between the connection line L31 and the connection line L32, a voltage between the connection line L32 and the connection line L33, and a voltage between the connection line L33 and the connection line L31, respectively.

<Example of Operation of Controller 4 when Battery B is Charged>

Firstly, when the controller 4 determines that the vehicle power converter 1 is connected to the AC power supply P through the external power supply device Ch, the controller 4 keeps a connection state between the AC-DC power conversion circuit 2 (smoothing capacitor Cs) and the connectors CR, CS, CT, Cn in a disconnected state by the switches SW3 to SW7. Here, a connection state in which the AC-DC power conversion circuit 2 and at least three of the four connectors CR, CS, CT, Cn are disconnected from each other is defined as the disconnected state by the switches. For example, in a state illustrated in FIG. 5, although the connector CR is connected to the AC-DC power conversion circuit 2 through the terminal NC of the switch SW6, the connector CS, CT, Cn are not connected to the AC-DC power conversion circuit 2 by the switches SW4 to SW7, so that the connection state between the AC-DC power conversion circuit 2 and the connectors CR, CN, CT, Cn is regarded as the disconnected state. Specifically, the controller 4 controls the switch SW3 so that the inductor L1 is connected to the vehicle compartment power feed portion Co. In addition, the controller 4 controls the switches SW4, SW5 so that the node between the switching elements Q17, Q18 is not connected to the connector Cn and the vehicle compartment power feed portion Co. The controller 4 controls the switch SW6 so that the inductor L2 is not connected to the connector CS. The controller 4 also controls the switch SW7 so that the inductor L3 is not connected to the connector CT.

Then, the controller 4 controls the operation of the bidirectional DC-DC power conversion circuit 3 to pre-charge the smoothing capacitor Cs. Note that stopping the operation of the AC-DC power conversion circuit 2 when the smoothing capacitor Cs is pre-charged prevents the AC power output from the AC-DC power conversion circuit 2 from being output to the outside of the vehicle power converter 1 through the vehicle compartment power feed portion Co even when the AC-DC power conversion circuit 2 is connected to the vehicle compartment power feed portion Co by the switches SW3, SW4, SW5.

Next, when the pre-charging of the smoothing capacitor Cs has been completed, the controller 4 controls the switch SW3 so that the inductor L1 is connected to the connector CR, controls the switches SW4, SW5 so that the node between the switching elements Q17, Q18 is not connected to the connector Cn, controls the switch SW6 so that the inductor L2 is connected to the connector CS, and controls the switch SW7 so that the inductor L3 is connected to the connector CT. This connection state is defined as a connected state when the three-phase AC power is input.

Then, the controller 4 controls the operation of each of the AC-DC power conversion circuit 2 and the bidirectional DC-DC power conversion circuit 3 so that the three-phase AC power output from the external power supply device Ch is converted to the DC power corresponding to the target DC power and the DC power is supplied to the battery B.

Note that the vehicle power converter 1 in FIG. 4 may also deal with a single-phase AC power as the input. When the single-phase AC power is input to the vehicle power converter 1, the connectors CR, Cn only serve as input terminals of the vehicle power converter 1. Here, a connection state in which the AC-DC power conversion circuit 2 (smoothing capacitor) and at least one of the connectors CR, Cn are disconnected from each other by the switches SW3, SW4, SW5, SW6 is defined as a disconnected state. When the pre-charging of the smoothing capacitor Cs has been completed, the controller 4 controls the switch SW3 so that the inductor L1 is connected to the connector CR, controls the switches SW4, SW5 so that the node between the switching elements Q17, Q18 is connected to the connector Cn, and controls the switch SW6 so that the inductor L2 is connected to the connector CR. This connection state is defined as a connected state. In this connection state, interleaving connection is formed using the inductors L1, L2 and reduces a load on each of the switching elements Q13 to Q16. In addition, the controller 4 may control the switch SW6 so that the inductor L2 is not connected to the connector CR. This connection state is also defined as the connected state. In this connection state, the inductor L2 and the switching elements Q15, Q16 do not work.

<Example of Operation of Controller 4 when Power is Supplied to Vehicle Compartment Power Feed Portion Co>

Firstly, when the controller 4 receives an instruction for supplying a power to the vehicle compartment power feed portion Co, which is sent from the vehicle side controller Cv, the controller 4 controls the switch SW3 so that the inductor L1 is connected to the vehicle compartment power feed portion Co and controls the switches SW4, SW5 so that the node between the switching elements Q17, Q18 is connected to the vehicle compartment power feed portion Co.

Then, the controller 4 turns on the switching elements Q13, Q18 and turns off the switching elements Q14 to Q17, and then, turns on the switching elements Q14, Q17 and turns off the switching elements Q13, Q15, Q16, Q18. This on-off operation is repeated by the controller 4.

<Example of Operation of Controller 4 when AC Power is Output from Connectors>

When the controller 4 receives the instruction for converting the power supplied from the battery B to the AC power and outputting the AC power to the outside of the vehicle power converter 1 through the connectors CR, Cn from the user, or the like, the controller 4 controls the switch SW3 so that the inductor L1 is connected to the connector CR and controls the switches SW4, SW5 so that the node between the switching elements Q17, Q18 is connected to the connector Cn. Then, the controller 4 turns on the switching elements Q13, Q18 and turns off the switching elements Q14 to Q17, and then, turns on the switching elements Q14, Q17 and turns off the switching elements Q13, Q15, Q16, Q18. This on-off operation is repeated by the controller 4.

In addition, when the controller 4 receives the instruction for converting the power supplied from the battery B to a single-phase three-wire AC power and outputting the single-phase three-wire AC power to the outside of the vehicle power converter 1 through CR, CS, Cn, from the user, or the like, the controller 4 controls the switch SW3 so that the inductor L1 is connected to the connector CR, controls the switches SW4, SW5 so that the node between the switching elements Q17, Q18 is connected to the connector Cn, and controls the switch SW6 so that the inductor L2 is connected to the connector CS. Then, the controller 4 repeats alternately turning on and off the switching elements Q13, Q14 and alternately turning on and off the switching elements Q15, Q16 to output the AC voltages to each of the connection lines L31, L32, which are shifted by 180 degrees relative to each other in phase. In addition, the controller 4 controls the switching elements Q17, Q18 so that a voltage measured by the voltage sensor Sv5 between the connection line L31 and the connection line L34 and a voltage measured by the voltage sensor Sv6 between the connection line L32 and the connection line L34 are the same magnitude and have opposite signs.

The vehicle power converter 1 according to the modified example 2-1 provides the same effects as the first to seventh effects. The vehicle power converter 1 according to the modified example 2-1 also provides the following eighth effect.

### Eighth Effect

The vehicle power converter 1 according to the modified example 2-1 may deal with not only the three-phase AC power but also the single-phase AC power as the input. In addition, the vehicle power converter 1 may supply the single-phase three-wire AC power.

Note that in the modified example 2-1, the switch SW5 may be omitted, and the switch SW6 may be formed of an electromagnetic relay with a normally open contact, similarly to the switch SW7.

### Modified Example 2-2

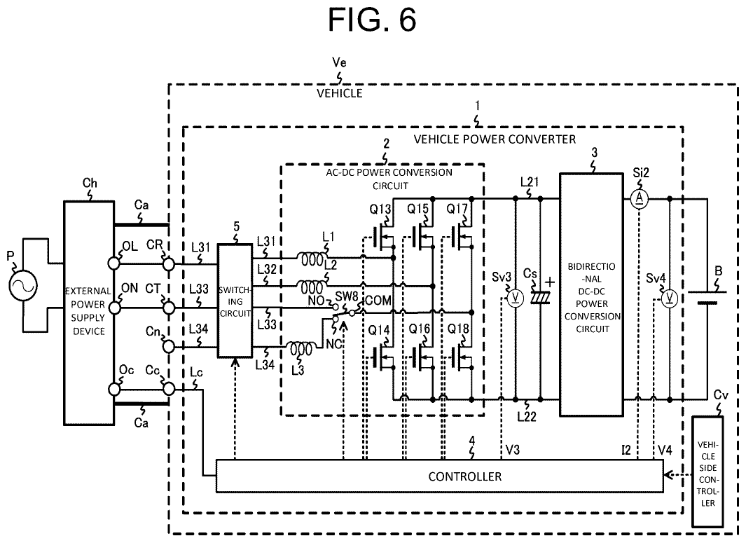

FIG. 6 is a diagram of a modified example 2-2 of the vehicle power converter 1 according to the present embodiment. Note that in FIG. 6, the same components as those illustrated in FIG. 4 are denoted by the same reference numerals, and the description of them will be omitted. Furthermore, in the vehicle power converter 1 illustrated in FIG. 6, the connector CS is omitted as compared with the vehicle power converter 1 illustrated in FIG. 4. The external power supply device Ch illustrated in FIG. 6 converts a single-phase AC power output from the AC power supply P of a single phase as the external power supply to a specified AC power and supplies the specified AC power to the vehicle power converter 1.

In the vehicle power converter 1 illustrated in FIG. 6, when the vehicle power converter 1 is connected to the external power supply device Ch through the charging cable Ca, the connector CR is connected to the output terminal OL of the external power supply device Ch through one power line in the charging cable Ca, the connector CT is connected to the output terminal ON the external power supply device Ch through the other power line in the charging cable Ca, and the connector Cc is connected to the terminal Oc of the external power supply device Ch through the signal line in the charging cable Ca. In this state, a power is ready to be supplied from the external power supply device Ch to the vehicle power converter 1, and the vehicle power converter 1 and the external power supply device Ch can communicate with each other.

The AC-DC power conversion circuit 2 illustrated in FIG. 6 further includes a switch SW8. The switch SW8 is formed of an electromagnetic relay with a changeover contact. In the switch SW8, a terminal COM is connected to the node between the switching elements Q17, Q18, a terminal NO is connected to the connection line L33, and a terminal NC is connected to the connection line L34 through the inductor L3. That is, the switch SW8 connects the node between the switching elements Q17, Q18 to the connection line L33 or the connection line L34.

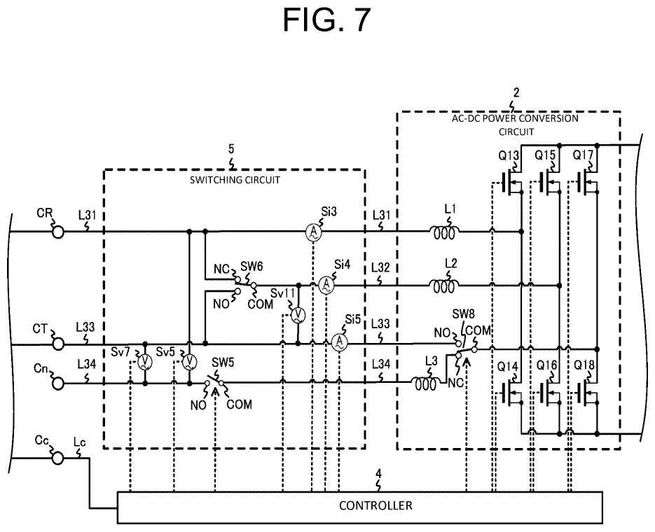

FIG. 7 is a diagram illustrating an example of the switching circuit 5 illustrated in FIG. 6. Note that in FIG. 7, the same components as those illustrated in FIG. 5 are denoted by the same reference numerals, and the description of them will be omitted.

In the switching circuit 5 illustrated in FIG. 7, one terminal of a voltage sensor Sv11 is connected between the switch SW6 to the AC-DC power conversion circuit 2 and the other terminal of the voltage sensor Sv11 is connected between the connector CT and the switch SW8. The voltage sensor Sv11 measures a voltage between the connection line L32 and the connection line L33. Note that in the switching circuit 5 illustrated in FIG. 7, the switches SW3, SW4, SW7 and the voltage sensors Sv6, Sv8, Sv9, Sv10 are omitted as compared with the switching circuit 5 illustrated in FIG. 5. Furthermore, in a case where the power is supplied from the AC power supply P of the single phase to the vehicle power converter 1 as illustrated in FIG. 6, the switch SW5 may be omitted.

In the switching circuit 5 illustrated in FIG. 7, the terminal COM of the switch SW5 is connected to the node between the switching elements Q17, Q18 through the inductor L3 and the switch SW8, and the terminal NO of the switch SW5 is connected to the connector Cn. In addition, in the switching circuit 5 illustrated in FIG. 7, the terminal COM of the switch SW6 is connected to the node between the switching elements Q15, Q16 through the inductor L2, the terminal NC of the switch SW6 is connected to the connector CR, and the terminal NO of the switch SW6 is connected to the connector CT. That is, the switch SW6 connects the node between the switching elements Q15, Q16 to the connector CR or the connector CT. In addition, the switches SW5, SW8 connect the node between the switching elements Q17, Q18 to the connector CT or the connector Cn or do not connect the node between the switching elements Q17, Q18 to the connector CT and the connector Cn.

<Example of Operation of Controller 4 when Battery B is Charged>

Firstly, when the controller 4 determines that the vehicle power converter 1 is connected to the AC power supply P through the external power supply device Ch, the controller 4 keeps a connection state between the AC-DC power conversion circuit 2 (smoothing capacitor Cs) and the connectors CR, CT in a disconnected state by the switches SW6, SW8. Here, a connection state in which the AC-DC power conversion circuit 2 and at least one of the two connectors CR, CT are disconnected from each other is defined as the disconnected state by the switches. For example, in a state of FIG. 7, although the connector CR is connected to the AC-DC power conversion circuit 2 through the terminal NC of the switch SW6, the connector CT is disconnected from the AC-DC power conversion circuit 2 by the switches SW6, SW8, so that the connection state between the AC-DC power conversion circuit 2 and the connectors CR, CT is regarded as the disconnected state. Specifically, the controller 4 controls the switch SW6 so that the node between the switching elements Q15, Q16 is connected to the connector CR. Furthermore, the controller 4 controls the switch SW8 so that the node between the switching elements Q17, Q18 is not connected to the connector CT. Note that the switch SW5 may be turned on or off.

Then, the controller 4 controls the operation of the bidirectional DC-DC power conversion circuit 3 to pre-charge the smoothing capacitor Cs. Note that stopping the operation of the AC-DC power conversion circuit 2 when the smoothing capacitor Cs is pre-charged prevents the AC power output from the AC-DC power conversion circuit 2 from being output to the outside of the vehicle power converter 1 through the connectors CR, CT, Cn even when the node between the switching elements Q17, Q18 is connected to the connector CT or the connector Cn.

Next, when the pre-charging of the smoothing capacitor Cs has been completed, the controller 4 controls the switch SW6 so that the node between the switching elements Q15, Q16 is connected to the connector CR and controls the switch SW8 so that the node between the switching elements Q17, Q18 is connected to the connector CT. This connection state is defined as a connected state when the single-phase AC power is input.

Then, the controller 4 controls the operation of each of the AC-DC power conversion circuit 2 and the bidirectional DC-DC power conversion circuit 3 so that the single-phase AC power output from the external power supply device Ch is converted to the DC power corresponding to the target DC power and the DC power is supplied to the battery B.

<Example of Operation of Controller 4 when AC Power is Output from Connectors (During Supply of Single-Phase AC Power (when Load to which Power is Supplied is Connected to Connectors CR, CT and is not Connected to Connector Cn))>

When the controller 4 receives the instruction for converting the DC power supplied from the battery B to the single-phase AC power and outputting the single-phase AC power to the outside of the vehicle power converter 1 through the connectors CR, CT from the user, or the like, the controller 4 controls the switch SW6 so that the node between the switching elements Q15, Q16 is connected to the connector CR, and controls the switch SW8 so that the node between the switching elements Q17, Q18 is connected to the connector CT. Then, the controller 4 turns on the switching elements Q13, Q15, Q18 and turns off the switching elements Q14, Q16, Q17, and then, turns on the switching elements Q14, Q16, Q17 and turns off the switching elements Q13, Q15, Q18. This on-off operation is repeated by the controller 4. Note that the switch SW5 may be turned on or off.

<Example of Operation of Controller 4 when AC Power is Output from the Connectors (During Supply of Single-Phase Three-Wire AC Power (when Load to which Power is Supplied is Connected to Connectors CR, CT, Cn))>

When the controller 4 receives the instruction for converting the DC power supplied from the battery B to the single-phase three-wire AC power and outputting the single-phase three-wire AC power to the outside of the vehicle power converter 1 through the connectors CR, CT, Cn from the user, or the like, the controller 4 controls the switch SW6 so that the node between the switching elements Q15, Q16 is connected to the connector CT, and controls the switches SW5, SW8 so that the node between the switching elements Q17, Q18 is connected to the connector Cn. Then, the controller 4 repeats alternately turning on and off the switching elements Q13, Q14 and alternately turning on and off the switching elements Q15, Q16 to output the AC voltages in the connection lines L31, L33, which are shifted by 180 degrees relative to each other in phase. In addition, the controller 4 controls the switching elements Q17, Q18 so that a voltage measured by the voltage sensor Sv5 between the connection line L31 and the connection line L34 and a voltage measured by the voltage sensor Sv7 between the connection line L33 and the connection line L34 are the same magnitude and have opposite signs.

<Example of Operation of Controller 4 when Determining Whether Switch SW6 is Fused>

When the AC power is output from the AC power supply P to the vehicle power converter 1 through the external power supply device Ch and the controller 4 controls the switch SW6 so that the terminal COM of the switch SW6 is connected to the terminal NO, the controller 4 compares a difference voltage ΔV between a voltage (peak voltage) measured by the voltage sensor Sv5 and a voltage (peak voltage) measured by the voltage sensor Sv7 with a voltage V11 measured by the voltage sensor Sv11. The controller 4 determines that the terminal COM and the terminal NC of the switch SW6 are fused to each other in a case where the difference voltage ΔV is equal to or substantially equal to the voltage V11. For example, when the controller 4 controls the switch SW6 so that the terminal COM of the switch SW6 is connected to the terminal NO, the controller 4 determines that the terminal COM and the terminal NC of the switch SW6 are fused to each other in a case where a difference between the difference voltage ΔV and the voltage V11 is the threshold voltage Vth3 or less.

The vehicle power converter 1 according to the modified example 2-2 provides the same effects as the first effect to fifth effect and the eighth effect. The vehicle power converter 1 according to the modified example 2-2 also provides the following ninth effect.

### Ninth Effect

The vehicle power converter 1 includes the switch SW6 and the voltage sensors Sv5, Sv7, Sv11. Accordingly, in the case where the AC power is output from the AC power supply P to the vehicle power converter 1 through the external power supply device Ch, when the controller 4 controls the switch SW6 so that the terminal COM of the switch SW6 is connected to the terminal NO, the controller 4 compares the difference voltage ΔV with the voltage V11. The controller 4 determines that the terminal COM and the terminal NC of the switch SW6 are fused to each other in the case where the difference voltage ΔV is equal to or substantially equal to the voltage V11. This makes it possible to determine whether the switch SW6 is fused.

### Modified Example 2-3

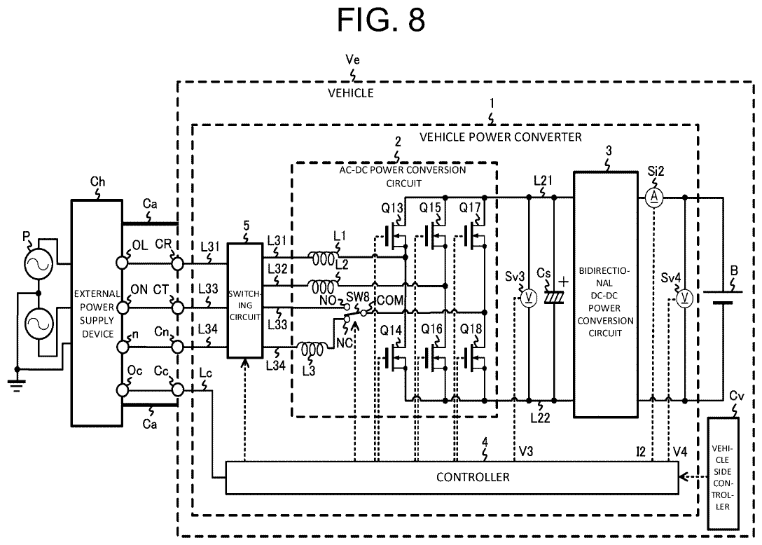

FIG. 8 is a diagram of a modified example 2-3 of the vehicle power converter 1 according to the present embodiment. Note that in FIG. 8, the same components as those illustrated in FIG. 6 are denoted by the same reference numerals, and the description of them will be omitted. The switching circuit 5 illustrated in FIG. 8 is similar to the switching circuit 5 illustrated in FIG. 7, for example. When the vehicle power converter 1 illustrated in FIG. 8 is connected to the external power supply device Ch through the charging cable Ca, the connector Cn of the vehicle power converter 1 is connected to the terminal n of the external power supply device Ch through the power line in the charging cable Ca. A neutral point of the AC power supply P is connected to the ground and also to the terminal n of the external power supply device Ch.

The external power supply device Ch illustrated in FIG. 8 converts the single-phase three-wire AC power output from the AC power supply P as the external power supply to a specified AC power and supplies the specified AC power to the vehicle power converter 1.

<Example of Operation of Controller 4 when Battery B is Charged>

Firstly, when the controller 4 determines that the vehicle power converter 1 is connected to the AC power supply P through the external power supply device Ch, the controller 4 keeps a connection state between the AC-DC power conversion circuit 2 (smoothing capacitor Cs) and the connectors CR, CT, Cn in a disconnected state by the switches SW5, SW6, SW8. Here, a connection state in which the AC-DC power conversion circuit 2 and at least two of the three connectors CR, CT, Cn are disconnected from each other is defined as the disconnected state by the switches. For example, the controller 4 controls the switch SW6 so that the node between the switching elements Q15, Q16 is connected to the connector CR. Furthermore, the controller 4 controls the switches SW5, SW8 so that the node between the switching elements Q17, Q18 is not connected to the connectors CT, Cn.

Then, the controller 4 controls the operation of the bidirectional DC-DC power conversion circuit 3 to pre-charge the smoothing capacitor Cs. Note that stopping the operation of the AC-DC power conversion circuit 2 when the smoothing capacitor Cs is pre-charged prevents the AC power output from the AC-DC power conversion circuit 2 from being output to the outside of the vehicle power converter 1 through the connectors CR, CT, Cn even when the node between the switching elements Q17, Q18 is connected to the connector CT or the connector Cn.

Next, when the pre-charging of the smoothing capacitor Cs has been completed, the controller 4 controls the switch SW6 so that the node between the switching elements Q15, Q16 is connected to the connector CR and controls the switch SW8 so that the node between the switching elements Q17, Q18 is connected to the connector CT. This connection state is defined as a connected state when the single-phase AC power is input.

Then, the controller 4 controls the operation of each of the AC-DC power conversion circuit 2 and the bidirectional DC-DC power conversion circuit 3 so that the single-phase AC power output from the external power supply device Ch is converted to the DC power corresponding to the target DC power and the DC power is supplied to the battery B.

The example of the operation of the controller 4 when the AC power (single-phase AC power or single-phase three-wire AC power) is output from the connectors in the modified example 2-3 is the same as the example of the operation of the controller 4 when the AC power is output from the connectors in the modified example 2-2, and thus, the description of the example of the operation will be omitted.

In addition, a check for whether the switch SW6 is fused in the modified example 2-3 is the same as the check for whether the switch SW6 is fused in the modified example 2-2, and thus, the description of the check will be omitted.

The vehicle power converter 1 according to the modified example 2-3 provides the same effects as the first to fifth effects, the eight effect, and the ninth effect.

### Modified Example 2-4

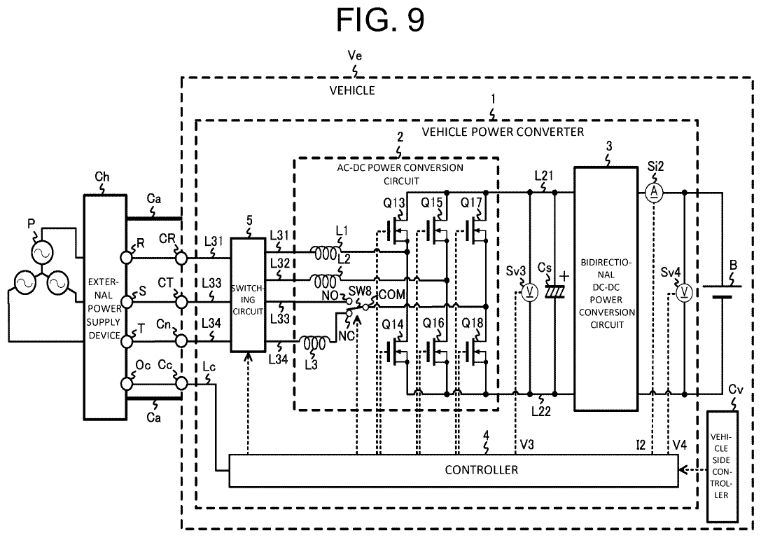

FIG. 9 is a diagram of a modified example 2-4 of the vehicle power converter 1 according to the present embodiment. Note that in FIG. 9, the same components as those illustrated in FIG. 6 are denoted by the same reference numerals, and the description of them will be omitted. The switching circuit 5 illustrated in FIG. 9 is similar to the switching circuit 5 illustrated in FIG. 7. In the vehicle power converter 1 illustrated in FIG. 9, when the vehicle power converter 1 is connected to the external power supply device Ch through the charging cable Ca, the connector CR of the vehicle power converter 1 is connected to the terminal R of the external power supply device Ch through the power line in the charging cable Ca, the connector CT of the vehicle power converter 1 is connected to the terminal S of the external power supply device Ch through the power line in the charging cable Ca, the connector Cn of the vehicle power converter 1 is connected to the terminal T of the external power supply device Ch through the power line in the charging cable Ca, and the connector Cc of the vehicle power converter 1 is connected to the terminal Oc of the external power supply device Ch through the signal line in the charging cable Ca.

The external power supply device Ch illustrated in FIG. 9 converts the three-phase AC power output from the AC power supply P as the external power supply to a specified AC power and supplied the specified AC power to the vehicle power converter 1.

<Example of Operation of Controller 4 when Battery B is Charged>

Firstly, when the controller 4 determines that the vehicle power converter 1 is connected to the AC power supply P through the external power supply device Ch, the controller 4 keeps a connection state between the AC-DC power conversion circuit 2 (smoothing capacitor Cs) and the connectors CR, CT, Cn in a disconnected state by the switches SW5, SW6, SW8. Here, a connection state in which the AC-DC power conversion circuit 2 and at least two of the three connectors CR, CT, Cn are disconnected from each other is defined as the disconnected state by the switches. For example, the controller 4 controls the switch SW6 so that the node between the switching elements Q15, Q16 is connected to the connector CR. Furthermore, the controller 4 controls the switches SW5, SW8 so that the node between the switching elements Q17, Q18 is not connected to the connectors CT, Cn

Then, the controller 4 controls the operation of the bidirectional DC-DC power conversion circuit 3 to pre-charge the smoothing capacitor Cs. Note that stopping the operation of the AC-DC power conversion circuit 2 when the smoothing capacitor Cs is pre-charged prevents the AC power output from the AC-DC power conversion circuit 2 from being output to the outside of the vehicle power converter 1 through the connectors CR, CT, Cn even when the node between the switching elements Q17, Q18 is connected to the connector CT or the connector Cn

Next, when the pre-charging of the smoothing capacitor Cs has been completed, the controller 4 controls the switch SW6 so that the node between the switching elements Q15, Q16 is connected to the connector CT and controls the switches SW5, SW8 so that the node between the switching elements Q17, Q18 is connected to the connector Cn. This connection state is defined as a connected state when the three-phase AC power is input.

Then, the controller 4 controls the operation of each of the AC-DC power conversion circuit 2 and the bidirectional DC-DC power conversion circuit 3 so that the three-phase AC power output from the external power supply device Ch is converted to the DC power corresponding to the target DC power and the DC power is supplied to the battery B.

The example of the operation of the controller 4 when the AC power (single-phase AC power or single-phase three-wire AC power) is output from the connectors in the modified example 2-4 is the same as the example of the operation of the controller 4 when the AC power is output from the connectors in the modified example 2-2, and thus, the description of the example of the operation will be omitted.

In addition, a check for whether the switch SW6 is fused in the modified example 2-4 is the same as the check for whether the switch SW6 is fused in the modified example 2-2, and thus, the description of the check will be omitted.

The vehicle power converter 1 according to the modified example 2-4 provides the same effects as the first to fifth effects, the eight effect, and the ninth effect.

### Modified Example 3

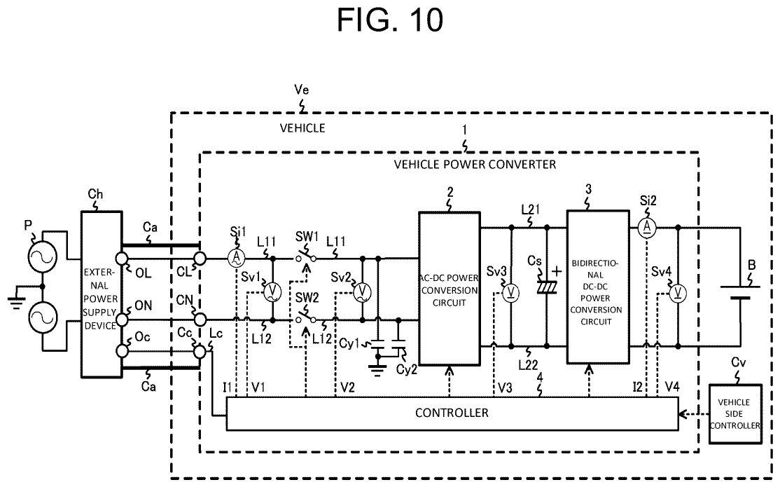

FIG. 10 is a diagram illustrating a modified example 3 of the vehicle power converter 1 according to the present embodiment. Note that in FIG. 10, the same components as those illustrated in FIG. 1 are denoted by the same reference numerals, and the description of them will be omitted.

The vehicle power converter 1 illustrated in FIG. 10 is different from the vehicle power converter 1 illustrated in FIG. 1 in that a capacitor Cy1 as a capacitor for reducing noise is provided between the ground and the connection line L11 connecting the switch SW1 to the AC-DC power conversion circuit 2, and a capacitor Cy2 as the capacitor for reducing noise is provided between the ground and the connection line L12 connecting the switch SW2 to the AC-DC power conversion circuit 2. That is, the switches (switches SW1, SW2) are provided on all of the corresponding connection lines L11, L12 on which the capacitors Cy1, Cy2 for reducing the noise are connected. Note that the AC power supply P is two AC power supplies which are shifted by 180 degrees relative to each other in phase and connected to each other. A neutral point of the AC power supply P is connected to the ground and opposite terminals of the AC power supply P are connected to the external power supply device Ch. That is, the opposite terminals of the single-phase three-wire AC power supply are connected to the external power supply device Ch. In addition, when the switches SW1, SW2 are turned off, the connection line L11 between the connector CL and the capacitor Cy1 and the connection line L12 between the connector CN and the capacitor Cy2 are each disconnected. In the vehicle power converter 1 illustrated in FIG. 4 and FIG. 8, the capacitors for reducing the noise may be provided between the connection lines L31 and the ground, between the connection line L32 and the ground, between the connection line L33 and the ground, and between the connection line L34 and the ground. Here, the connection lines L31, L32, L33, L34 are provided between the switching circuit 5 and the AC-DC power conversion circuit 2.

Similarly to the controller 4 illustrated in FIG. 1, the controller 4 illustrated in FIG. 10 keeps the connection state between the smoothing capacitor Cs and the connectors CL, CN in the disconnected state by the switches SW1, SW2 from an end of the previous charging of the battery B until an end of the pre-charging of the smoothing capacitor Cs. In particular, in the modified example 3, both connection lines L11, L12 are disconnected by turning off both the switches SW1, SW2.

The vehicle power converter 1 according to the modified example 3 provides the same effects as the first to sixth effects. The vehicle power converter 1 according to the modified example 3 also provides the following tenth effect.

### Tenth Effect

The switches SW1, SW2 are provided between the AC-DC power conversion circuit 2 and the connectors CL, CN. The capacitors Cy1, Cy2 for reducing the noise are each provided between the ground and the connection line L11 connecting the switch SW1 to the AC-DC power conversion circuit 2 and between the ground and the connection line L12 connecting the switch SW2 to the AC-DC power conversion circuit 2. The switches (switches SW1, SW2) are provided on all of the corresponding connection lines L11, L12 on which the capacitors Cy1, Cy2 for reducing the noise are connected. Accordingly, in a configuration of the modified example 3, it is possible that all of the corresponding connection lines on which the capacitors for reducing the noise are provided are disconnected.

In a case where the AC power supply P is connected to the ground and only one of the switches SW1, SW2 is provided, for example, the switch SW2 is not provided, even when the connection state between the smoothing capacitor Cs and the connectors CL, CN are in the disconnected state by turning off the switch SW1, a loop through the connection line L12, the capacitor Cy2, the ground, the AC power supply P, the external power supply device Ch, and the connection line L12 is formed, which generates a reactive current. However, in the modified example 3, the switches SW1, SW2 are turned off to disconnect both the connection lines L11, L12 on which the capacitors for reducing the noise are provided, which suppresses the generation of the reactive current. Note that even when the AC power supply P is only one similarly to FIG. 1, in a case where one of the opposite terminals of the AC power supply P is connected to the ground, the same issue occurs. Also in this case, the vehicle power converter 1 according to the modified example 3 suppresses that the reactive current is generated.

### Modified Example 4

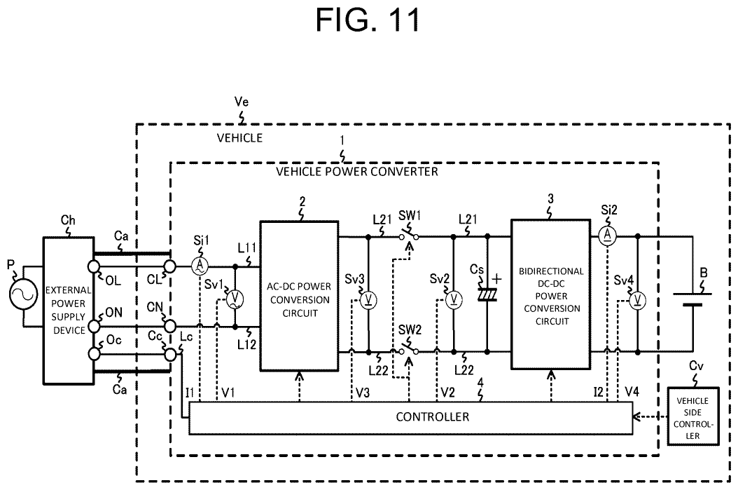

FIG. 11 is a diagram illustrating a modified example 4 of the vehicle power converter 1 according to the present embodiment. Note that in FIG. 11, the same components as those illustrated in FIG. 1 are denoted by the same reference numerals, and the description of them will be omitted.

In the vehicle power converter 1 illustrated in FIG. 11, the switch SW1 is provided between the connector CL and the smoothing capacitor Cs on the connection line L21 connecting the AC-DC power conversion circuit 2 to the smoothing capacitor Cs. The switch SW2 is provided between the connector CN and the smoothing capacitor Cs on the connection line L22 connecting the AC-DC power conversion circuit 2 to the smoothing capacitor Cs. In addition, the vehicle power converter 1 illustrated in FIG. 11 is different from the vehicle power converter 1 illustrated in FIG. 1 in that the voltage sensor Sv2 (second voltage sensor) is provided between the connection line L21 connecting the switch SW1 to the bidirectional DC-DC power conversion circuit 3 and the connection line L22 connecting the switch SW2 to the bidirectional DC-DC power conversion circuit 3. Note that the voltage sensor Sv3 (first voltage sensor) is provided between the connection line L21 connecting the AC-DC power conversion circuit 2 to the switch SW1 and the connection line L22 connecting the AC-DC power conversion circuit 2 to the switch SW2.

When the controller 4 illustrated in FIG. 11 determines that the vehicle power converter 1 is connected to the AC power supply P through the external power supply device Ch, the controller 4 controls the operation of the bidirectional DC-DC power conversion circuit 3 while keeping a connection state between the smoothing capacitor Cs and the connectors CL, CN in the disconnected state by the switches SW1, SW2, so that the power output from the battery B is supplied to the smoothing capacitor Cs to pre-charge the smoothing capacitor Cs.

When the AC power is output from the external power supply device Ch to the vehicle power converter 1 and the connection state between the smoothing capacitor Cs and the connectors CL, CN is kept in the disconnected state by the switches SW1, SW2, the controller 4 illustrated in FIG. 11 determines that at least one of the switches SW1, SW2 is fused in a case where the voltage V3 detected by the voltage sensor Sv3 is the threshold voltage Vth1 (first threshold voltage) or more and the voltage V2 detected by the voltage sensor Sv2 is the threshold voltage Vth2 (second threshold voltage) or more. This makes it possible to determine whether at least one of the switches SW1, SW2 is fused.

In addition, when the AC power is output from the AC power supply P to the vehicle power converter 1 through the external power supply device Ch and the connection state between the smoothing capacitor Cs and the connectors CL, CN is kept in the disconnected state by the switches SW1, SW2, the controller 4 illustrated in FIG. 11 may be configured such that the controller 4 changes the specified time t (the threshold voltage, the threshold current, the specified threshold current in the accumulated current amount) in accordance with the voltage V1 detected by the voltage sensor Sv1. For example, specifically, the controller 4 may be configured such that the controller 4 makes the specified time t shorter as the voltage V1 decreases. This shortens the time from when the vehicle power converter 1 is electrically connected to the external power supply device Ch until the charging of the battery B is started. Furthermore, the voltage V3 detected by the voltage sensor Sv3 may be used instead of the voltage V1.

The vehicle power converter 1 according to the modified example 4 provides the same effects as the first to fifth effects. The vehicle power converter 1 according to the modified example 4 also provides the following eleventh effect.

### Eleventh Effect

The vehicle power converter 1 includes the switches SW1, SW2, the voltage sensor Sv3, and the voltage sensor Sv2. Accordingly, when the AC power is output from the AC power supply P to the vehicle power converter 1 through the external power supply device Ch and the connection state between the smoothing capacitor Cs and the connectors CL, CN is kept in the disconnected state by the switches SW1, SW2, the controller 4 determines that at least one of the switches SW1, SW2 is fused in the case where the voltage V3 detected by the voltage sensor Sv3 is the threshold voltage Vth1 (first threshold voltage) or more and the voltage V2 detected by the voltage sensor Sv2 is the threshold voltage Vth2 (second threshold voltage) or more. This makes it possible to determine whether at least one of the switches SW1, SW2 is fused.

### Modified Example 5

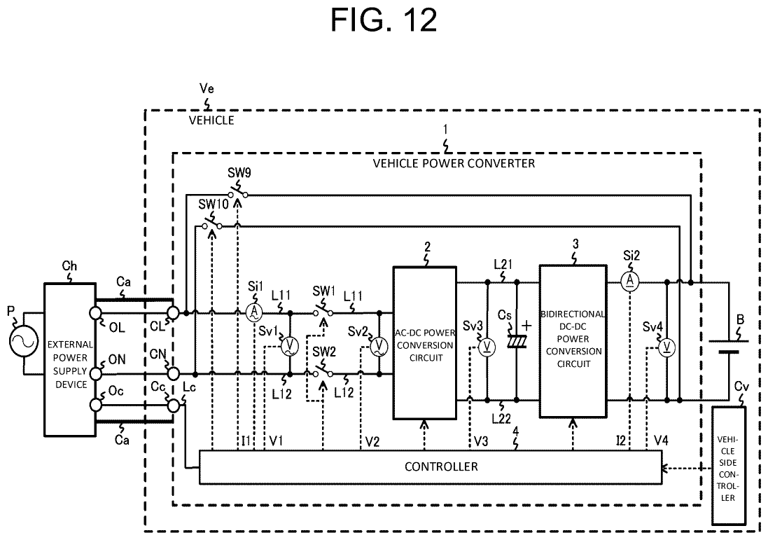

FIG. 12 is a diagram illustrating a modified example 5 of the vehicle power converter 1 according to the present embodiment. Note that in FIG. 12, the same components as those illustrated in FIG. 1 are denoted by the same reference numerals, and the description of them will be omitted. In the present embodiment, the voltage sensor Sv1 is an analog sensor, and the controller 4 may determine that an input voltage between the connection lines L11, L12 is an AC voltage or a DC voltage by detecting a frequency of the voltage V1, which is detected by the voltage sensor Sv1. In addition, the connectors CL, CN, Cc are connectable to both of a connector for an AC power supply and a connector for a DC power supply. In addition, FIG. 12 illustrates a state where the vehicle power converter 1 is connected to the external power supply device Ch to which the AC power is input from the AC power supply P. However, the following will also describe a state where the connectors CL, CN, Cc each have a shape connectable to an external power supply device to which a DC power is input from a DC power supply and the connectors CL, CN, Cc are connected to such an external power supply device.

The vehicle power converter 1 illustrated in FIG. 12 further includes switches SW9, SW10. The switches SW9, SW10 are each formed of an electromagnetic relay with a normally open contact, for example. One terminal of the switch SW9 is connected to the connector CL, and the other terminal of the switch SW9 is connected to the positive terminal of the battery B. One terminal of the switch SW10 is connected to the connector CN, and the other terminal of the switch SW10 is connected to the negative terminal of the battery B. That is, the switches SW9, SW10 each serve as a bypass switch for bypassing the AC-DC power conversion circuit 2 and the bidirectional DC-DC power conversion circuit 3 and connecting the battery B and the connectors CL, CN.

When the power supply is determined to be an AC power supply based on the voltage V1 detected by the voltage sensor Sv1, the controller 4 illustrated in FIG. 12 determines that the vehicle power converter 1 is connected to the AC power supply P through the external power supply device Ch. That is, this corresponds to a case where the power input to the connectors CL, CN is an AC power. In this case, the controller 4 executes the battery charging preparation operation. While a connection state between the smoothing capacitor Cs and the connector CL, CN is kept in the disconnected state by turning off at least one of the switches SW1, SW2, the smoothing capacitor Cs are pre-charged. Here, at least one of the switches SW9, SW10 is kept in the off-state. After the power is supplied from the battery B to the smoothing capacitor Cs, the controller 4 causes the connection state between the smoothing capacitor Cs and the connectors CL, CN to transition to the connected state by turning on the switches SW1, SW2 and keeps the switches SW9, SW10 in the off-state, and then, the controller 4 controls the operation of each of the AC-DC power conversion circuit 2 and the bidirectional DC-DC power conversion circuit 3 so that the battery B is charged by the AC power supplied from the external power supply device Ch.

The following will describe the case where the vehicle power converter 1 is connected to the external power supply device to which the DC power is input from the DC power supply. When the power supply is determined to be a DC power supply based on the voltage V1 detected by the voltage sensor Sv1, the controller 4 determines that the vehicle power converter 1 is connected to the DC power supply, which is not illustrated, through the external power supply device Ch. That is, this corresponds to a case where the power input to the connectors CL, CN is a DC power. In this case, the controller 4 does not execute the battery charging preparation operation. The controller 4 keeps the connection state between the smoothing capacitor Cs and the connectors CL, CN in the disconnected state by the switches SW1, SW2 and turns the switches SW9, SW10 from off to on, so that the DC power is supplied from the external power supply device Ch to the battery B through the switches SW9, SW10. Thus, the battery B is charged.

Note that the controller 4 illustrated in FIG. 12 may determine whether the power input to the connectors CL, CN is an AC power or a DC power by performing wired communication with the external power supply device Ch using the signal line in the charging cable Ca and the signal line Lc or by performing wireless communication with the external power supply device Ch. Alternately, the controller 4 illustrated in FIG. 12 may determine whether the power input to the connectors CL, CN is an AC power or a DC power using signals sent from the vehicle side controller Cv. A DC voltage sensor and an AC voltage sensor may be each provided as the voltage sensor Sv1.

In the vehicle power converter 1 illustrated in FIG. 12, as the vehicle power converter 1 illustrated in FIG. 11, the switches SW1, SW2 may be respectively provided on the power lines L21, L22 between the AC-DC power conversion circuit 2 and the smoothing capacitor Cs.

In addition, when the AC power is output from the external power supply device Ch to the vehicle power converter 1 and the connection state between the smoothing capacitor Cs and the connectors CL, CN is kept in the disconnected state by the switches SW1, SW2, SW9, SW10, the controller 4 illustrated in FIG. I2 may determine that at least one of the switches SW1, SW2 are fused in the case where the voltage V1 detected by the voltage sensor Sv1 is the threshold voltage Vth1 (first threshold voltage) or more and the voltage V2 detected by the voltage sensor Sv2 is the threshold voltage Vth2 (second threshold voltage) or more. This makes it possible to determine whether at least one of the switches SW1, SW2 is fused. The controller 4 may determine whether at least one of the switches SW9, SW10 is fused using the voltage V4 detected by the voltage sensor Sv4.

Furthermore, when the AC power is output from the AC power supply P to the vehicle power converter 1 through the external power supply device Ch and the connection state between the smoothing capacitor Cs and the connectors CL, CN is kept in the disconnected state by the switches SW1, SW2, SW9, SW10, the controller 4 illustrated in FIG. 12 may be configured such that the controller 4 changes the specified time t (the threshold voltage, the threshold current, the specified threshold current in the accumulated current amount) in accordance with the voltage V1 detected by the voltage sensor Sv1. For example, specifically, the controller 4 may be configured such that the controller 4 makes the specified time t shorter as the voltage V1 decreases. This shortens the time from when the vehicle power converter 1 is electrically connected to the external power supply device Ch until the charging of the battery B is started.

The vehicle power converter 1 according to the modified example 5 provides the same effects as the first to sixth effects. The vehicle power converter 1 according to the modified example 5 also provides the following twelfth effect.

### Twelfth Effect

When the power input to the connectors CL, CN is an AC power, the controller 4 executes the battery charging preparation operation. When the power input to the connectors CL, CN is a DC power, the controller 4 does not execute the battery charging preparation operation and keeps the connection state between the smoothing capacitor Cs and the connectors CL, CN in the disconnected state by the switches SW1, SW2. Accordingly, even when the DC power is input to the connectors CL, CN, the AC-DC power conversion circuit 2 and the smoothing capacitor Cs are disconnected from the connectors CL, CN, so that there is no problem even when the DC power is input. That is, any dedicated connector for inputting the DC power supplied from the external power supply device Ch need not be separately provided from the connectors CL, CN, so that an increase of manufacturing costs of the vehicle power converter 1 is suppressed. In addition, when the power supplied from the external power supply device Ch is a DC power, the smoothing capacitor Cs need not be pre-charged, so that unnecessary battery charging preparation operation is omitted.

The present disclosure is not limited to the above-described embodiment, and may be modified within a gist of the present disclosure.

The vehicle power converter 1 may be directly connected to the AC power supply P without through the external power supply device Ch. Specifically in the modified example 5, the vehicle power converter 1 may be directly connected to the DC power supply without through the external power supply device Ch.

The terminal NO and the terminal NC of the electromagnetic relay with the changeover contact may be swapped. The electromagnetic relay with the normally open contact may be replaced with an electromagnetic relay with a normally closed contact. Here, when the control signals are not input to each switch, the terminal COM of each switch is connected to the terminal NC. However, in a case where each switch in this state is not in the disconnected state, it is necessary to set each switch in the disconnected state by switching each switch from the terminal NC to the terminal NO in advance before the controller 4 determines that the vehicle power converter 1 is connected to an external power supply. The controller 4 only needs to input the control signals to each switch as required.

When there is no need to output the AC power from the side of the battery B to the connector or the vehicle compartment power feed portion Co, the configuration of the AC-DC power conversion circuit 2 is not limited to the configuration of the circuit illustrated in FIG. 2A, FIG. 4, and FIG. 6 as long as an input AC power to the AC-DC power conversion circuit 2 is at least rectified. For example, the AC-DC power conversion circuit 2 may have a diode rectifier circuit on a side of the connectors. Here, a positive output terminal of the diode rectifier circuit may be connected to the one terminal of the inductor L, and a negative output terminal of the diode rectifier circuit may be connected to the source terminal of the switching element Q2, and the phase including the switching elements Q3, Q4 may be omitted, so that the AC-DC power conversion circuit 2 may have only the phase including the switching elements Q1, Q2. Furthermore, when the power factor of the AC-DC power conversion circuit 2 does not need to be corrected, the AC-DC power conversion circuit 2 may be formed of only the diode rectifier circuit.

When the vehicle power converter 1 deals with the three-phase AC power as the input as in the modified example 2-1 and the connector Cn is omitted, a connection state in which the AC-DC power conversion circuit 2 and at least two of the three connectors CR, CS, CT is disconnected from each other may be defined as a disconnected state.

In the modified example 2-1, the switch SW5 may be omitted. In addition, the vehicle compartment power feed portion Co may be omitted and the electromagnetic relay with the normally open contact or the electromagnetic relay with the normally closed contact may be used as the switches SW3, SW4.

In the modified example 3 and the modified example 5, the switches SW1, SW2 may be replaced with the switches SW3, SW4, and the vehicle compartment power feed portion Co may be provided as in the modified example 1.

The capacitors for reducing the noise as in the modified example 3 may be applied to the circuit for the three-phase AC power as in the modified example 2-1 or the circuit for the single-phase three-wire AC power as in the modified example 2-3.

The bypass passage, which bypasses the AC-DC power conversion circuit 2 and the bidirectional DC-DC power conversion circuit 3 and connects the connectors CL, CN to the battery B through the switches SW9, SW10, is provided in the vehicle power converter 1 in the modified example 5. However, the bypass passage may be provided outside the vehicle power converter 1. Furthermore, a desired power converter, relay, capacitor, or the like may be provided in the bypass passage.

The control when the AC power is input to the connectors and the control when the DC power is input to the connector in the modified example 5 may be applied to the modification example 2-1 or the modification example 2-4, which deal with the three-phase AC power as the input.

The features of the above-described embodiment will be summarized below.

### Supplementary Note 1

A vehicle power converter mounted on a vehicle, the vehicle power converter including:
connectors to which a power output from an external power supply is input;
an AC-DC power conversion circuit that converts, when the power input to the connectors is an AC power, the AC power to a DC power by rectifying the AC power;
a smoothing capacitor that smooths the DC power rectified by the AC-DC power conversion circuit;
a bidirectional DC-DC power conversion circuit that converts the DC power smoothed by the smoothing capacitor to a DC power corresponding to a target DC power and supplies the DC power to a battery mounted on the vehicle;
a switch that is provided between the smoothing capacitor and at least one of the connectors; and
a controller that controls operation of each of the AC-DC power conversion circuit, the bidirectional DC-DC power conversion circuit, and the switch, characterized in that
the controller executes battery charging preparation operation when the controller determines that the vehicle power converter is connected to the external power supply, and
in the battery charging preparation operation, after the controller controls the operation of the bidirectional DC-DC power conversion circuit while keeping a connection state between the smoothing capacitor and the connectors in a disconnected state by the switch such that a power output from the battery is supplied to the smoothing capacitor, the controller causes a connection state of the switch to transition from a disconnected state to a connected state.

### Supplementary Note 2

The vehicle power converter according to supplementary note 1, characterized in that
in the battery charging preparation operation, when a specified time has elapsed since a start of the supply of the power from the battery to the smoothing capacitor, the controller causes the connection state of the switch to transition from the disconnected state to the connected state,
the specified time is equal to or longer than a time required for a voltage across the smoothing capacitor to reach a voltage such that a current flowing from the AC-DC power conversion circuit to the smoothing capacitor when the connection state of the switch is transitioned to the connected state is equal to or less than an allowable current of the smoothing capacitor, and
the specified time is equal to or shorter than a time required for the voltage across the smoothing capacitor to reach a peak voltage of the AC power input from the external power supply or a voltage of the DC power supplied from the AC-DC power conversion circuit.

### Supplementary Note 3

The vehicle power converter according to supplementary note 1 or 2, further including
a vehicle compartment power feed portion from which an AC power is supplied to a vehicle compartment, characterized in that
the AC-DC power conversion circuit is a bidirectional circuit that converts a DC power on a side of the smoothing capacitor to an AC power and outputs the AC power toward the connectors,
the switch is provided between the AC-DC power conversion circuit and the at least one of the connectors, and
the switch connects the AC-DC power conversion circuit to the connectors or connect the AC-DC power conversion circuit to the vehicle compartment power feed portion.

### Supplementary Note 4

The vehicle power converter according to any one of supplementary notes 1 to 3, further including:
a first voltage sensor that is provided between the connectors and the switch, the switch being provided between the AC-DC power conversion circuit and the at least one of the connectors; and
a second voltage sensor that is provided between the AC-DC power conversion circuit and the switch, characterized in that
when the controller keeps the connection state between the smoothing capacitor and the connectors in the disconnected state by the switch, the controller determines that the switch is fused in a case where a first voltage detected by the first voltage sensor is a first threshold voltage or more and a second voltage detected by the second voltage sensor is a second threshold voltage or more.

### Supplementary Note 5

The vehicle power converter according to any one of supplementary notes 1 to 3, further including:
a first voltage sensor that is provided between the AC-DC power conversion circuit and the switch, the switch being provided between the AC-DC power conversion circuit and the smoothing capacitor; and
a second voltage sensor that is provided between the bidirectional DC-DC power conversion circuit and the switch, characterized in that
when the controller keeps the connection state between the smoothing capacitor and the connectors in the disconnected state by the switch, the controller determines that the switch is fused in a case where a first voltage detected by the first voltage sensor is a first threshold voltage or more and a second voltage detected by the second voltage sensor is a second threshold voltage or more.

### Supplementary Note 6

The vehicle power converter according to supplementary note 2, further including
a voltage sensor that is provided between the connectors and the switch, characterized in that
the controller makes the specified time shorter as a voltage detected by the voltage sensor decreases.

### Supplementary Note 7

The vehicle power converter according to any one of supplementary notes 1 to 4 and supplementary note 6, characterized in that
the switch includes a plurality of the switches,
the switches are provided between the AC-DC power conversion circuit and the connectors,
the vehicle power converter includes capacitors that are provided between a ground and corresponding connection lines connecting the switches to the AC-DC power conversion circuit, and
the switches are provided on all of the corresponding connection lines on which the capacitors are connected.

### Supplementary Note 8

The vehicle power converter according to any one of supplementary notes 1 to 7, characterized in that
when the power input to the connectors is an AC power, the controller executes the battery charging preparation operation, and
when the power input to the connectors is a DC power, the controller does not execute the battery charging preparation operation and keeps the connection state of the switch in the disconnected state.

What is claimed is:

1. A vehicle power converter mounted on a vehicle, the vehicle power converter comprising:
connectors to which a power output from an external power supply is input;
an AC-DC power conversion circuit that converts, when the power input to the connectors is an AC power, the AC power to a DC power by rectifying the AC power;
a smoothing capacitor that smooths the DC power rectified by the AC-DC power conversion circuit;
a bidirectional DC-DC power conversion circuit that converts the DC power smoothed by the smoothing capacitor to a DC power corresponding to a target DC power and supplies the DC power to a battery mounted on the vehicle;
a switch that is provided between the smoothing capacitor and at least one of the connectors; and
a controller that controls operation of each of the AC-DC power conversion circuit, the bidirectional DC-DC power conversion circuit, and the switch, wherein
the controller executes battery charging preparation operation when the controller determines that the vehicle power converter is connected to the external power supply, and
in the battery charging preparation operation, after the controller controls the operation of the bidirectional DC-DC power conversion circuit while keeping a connection state between the smoothing capacitor and the connectors in a disconnected state by the switch such that a power output from the battery is supplied to the smoothing capacitor, the controller causes a connection state of the switch to transition from a disconnected state to a connected state.

2. The vehicle power converter according to claim 1, wherein
in the battery charging preparation operation, when a specified time has elapsed since a start of the supply of the power from the battery to the smoothing capacitor, the controller causes the connection state of the switch to transition from the disconnected state to the connected state,
the specified time is equal to or longer than a time required for a voltage across the smoothing capacitor to reach a voltage such that a current flowing from the AC-DC power conversion circuit to the smoothing capacitor when the connection state of the switch is transitioned to the connected state is equal to or less than an allowable current of the smoothing capacitor, and
the specified time is equal to or shorter than a time required for the voltage across the smoothing capacitor to reach a peak voltage of the AC power input from the external power supply or a voltage of the DC power supplied from the AC-DC power conversion circuit.

3. The vehicle power converter according to claim 1, further comprising
a vehicle compartment power feed portion from which an AC power is supplied to a vehicle compartment, wherein
the AC-DC power conversion circuit is a bidirectional circuit that converts a DC power on a side of the smoothing capacitor to an AC power and outputs the AC power toward the connectors,
the switch is provided between the AC-DC power conversion circuit and the at least one of the connectors, and
the switch connects the AC-DC power conversion circuit to the connectors or connect the AC-DC power conversion circuit to the vehicle compartment power feed portion.

4. The vehicle power converter according to claim 1, further comprising:
a first voltage sensor that is provided between the connectors and the switch, the switch being provided between the AC-DC power conversion circuit and the at least one of the connectors; and
a second voltage sensor that is provided between the AC-DC power conversion circuit and the switch, wherein
when the controller keeps the connection state between the smoothing capacitor and the connectors in the disconnected state by the switch, the controller determines that the switch is fused in a case where a first voltage detected by the first voltage sensor is a first threshold voltage or more and a second voltage detected by the second voltage sensor is a second threshold voltage or more.

5. The vehicle power converter according to claim 1, further comprising:
a first voltage sensor that is provided between the AC-DC power conversion circuit and the switch, the switch being provided between the AC-DC power conversion circuit and the smoothing capacitor; and
a second voltage sensor that is provided between the bidirectional DC-DC power conversion circuit and the switch, wherein
when the controller keeps the connection state between the smoothing capacitor and the connectors in the disconnected state by the switch, the controller determines that the switch is fused in a case where a first voltage detected by the first voltage sensor is a first threshold voltage or more and a second voltage detected by the second voltage sensor is a second threshold voltage or more.

6. The vehicle power converter according to claim 2, further comprising
a voltage sensor that is provided between the connectors and the switch, wherein
the controller makes the specified time shorter as a voltage detected by the voltage sensor decreases.

7. The vehicle power converter according to claim 1, wherein
the switch includes a plurality of the switches,
the switches are provided between the AC-DC power conversion circuit and the connectors,
the vehicle power converter includes capacitors that are provided between a ground and corresponding connection lines connecting the switches to the AC-DC power conversion circuit, and
the switches are provided on all of the corresponding connection lines on which the capacitors are connected.

8. The vehicle power converter according to claim 1, wherein
when the power input to the connectors is an AC power, the controller executes the battery charging preparation operation, and
when the power input to the connectors is a DC power, the controller does not execute the battery charging preparation operation and keeps the connection state of the switch in the disconnected state.
